(19) United States
(12) Patent Application Publication
(10) Pub. No.: US 2022/0075659 A1
(43) Pub. Date: Mar. 10, 2022

(54) RUNTIME CONFIGURABLE REGISTER FILES FOR ARTIFICIAL INTELLIGENCE WORKLOADS

(71) Applicant: Intel Corporation, Santa Clara, CA (US)

(72) Inventors: Debabrata Mohapatra, San Jose, CA (US); Arnab Raha, Santa Clara, CA (US); Deepak Abraham Mathaikutty, Chandler, AZ (US); Raymond Jit-Hung Sung, San Francisco, CA (US); Cormac Michael Brick, San Francisco, CA (US)

(73) Assignee: Intel Corporation, Santa Clara, CA (US)

(21) Appl. No.: 17/530,156

(22) Filed: Nov. 18, 2021

(51) Int. Cl. G06F 9/50; G06F 9/30; G06F 7/544; G06N 3/04

(52) U.S. Cl. CPC G06F 9/5038; G06F 9/5011; G06N 3/04; G06F 9/30138; G06F 7/5443; G06F 9/30123

(57) ABSTRACT

There is disclosed a system and method of performing an artificial intelligence (AI) inference, including: programming an AI accelerator circuit to solve an AI problem with a plurality of layer-specific register file (RF) size allocations, wherein the AI accelerator circuit comprises processing elements (PEs) with respective associated RFs, wherein the RFs individually are divided into K sub-banks of size B bytes, wherein B and K are integers, and wherein the RFs include circuitry to individually allocate a sub-bank to one of input feature (IF), output feature (OF), or filter weight (FL), and wherein programming the plurality of layer-specific RF size allocations comprises accounting for sparse data within the layer; and causing the AI accelerator circuit to execute the AI problem, including applying the layer-specific RF size allocations at run-time.

### TECHNICAL FIELD

The present specification relates to the field of artificial intelligence, and more particularly, though not exclusively, to a runtime configurable register file for artificial intelligence workloads.

### BACKGROUND

Artificial intelligence is a subfield of computer science in which computers or circuits are programmed to learn from data and to update their algorithms based on the learning. A popular type of artificial intelligence (AI) circuit is the neural network (NN). When an NN has multiple convolution layers between the input layer and the output layer, it may be referred to as a deep neural network (DNN). A popular species of DNN is the convolutional neural network (CNN). To realize performance advantages, an AI circuit may be realized in a hardware accelerator, which may be for example an application-specific integrated circuit (ASIC), a field-programmable gate array (FPGA), or some other hardware platform. The accelerator may be used to offload the AI task to a hardware circuit, where it can be performed faster than in a general-purpose processor.

The accelerator may operate on a plurality of input and output tensors, such as an input feature (IF), output feature (OF), and weight of filter (FL). These may be stored in dedicated register files, which may be high-speed memory circuits associated with respective processing element in the AI accelerator circuit. Register files (RF) are much faster to access than higher-level memories, such as static random access memory (SRAM). In at least some existing systems, the RF is statically allocated between IF, OF, and FL. For example, each tensor may be allocated a 64-byte register. Static register allocations can, in at least some cases, lead to inefficiencies in memory management.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of a hardware circuit, in accordance with various embodiments.

FIG. 2 is a block diagram of a subcircuit, in accordance with various embodiments.

FIG. 3A is a block diagram of selected elements of a static RF ecosystem, in accordance with various embodiments.

FIG. 3B is an alternative schedule generator, in accordance with various embodiments.

FIG. 4 is a block diagram of two register files illustrating differences between a fixed capacity register file and a dynamic register file, in accordance with various embodiments.

FIG. 5 is a block diagram illustrating selected aspects of an elastic register file scheme, in accordance with various embodiments.

FIG. 6 is a graph that illustrates the relative hardware cost of different configurations, in accordance with various embodiments.

FIG. 7 is a graph that illustrates the percent reduction in total SRAM load accesses from using an example elastic register file, in accordance with various embodiments.

FIG. 8 is a block diagram of selected elements of a system-on-a-chip (SoC), in accordance with various embodiments.

FIG. 9 illustrates machine learning according to a “textbook” problem with real-world applications, in accordance with various embodiments.

FIG. 10 is a flowchart of a method that may be used to train a neural network, in accordance with various embodiments.

FIG. 11 is a flowchart of a method of using a neural network to classify an object, in accordance with various embodiments.

FIG. 12 is a block diagram illustrating selected elements of an analyzer engine, in accordance with various embodiments.

FIG. 13 is a block diagram of a circuit programming ecosystem, in accordance with various embodiments.

FIG. 14 is a flow chart of a method of programming a hardware circuit, in accordance with various embodiments.

### DETAILED DESCRIPTION

Overview

The present specification provides for flexible or elastic RFs within an AI accelerator circuit, or other circuits that may benefit from elastic registers. In some existing systems, a register file (RF) is assigned to each processing element (PE). divided between three separate tensors (e.g., IF, OF, and FL). If each tensor has 64 bytes allocated, for example, the total RF is 192 bytes. Because the accelerator is a hardware circuit, the RF has a fixed configuration, with a fixed division between the three registers for the three tensors.

Some existing systems have sought to better use the RF space, for example by dividing the RF into non-uniform sizes, such as 128 bytes for IF, and 32 bytes each for OF and FL. For example, an FPGA can be programmed to provide a hardware circuit at speeds that are similar to those realized in an ASIC. An FPGA can be programmed with a non-uniform register file (e.g., the sizes of the IF, FL, and OF registers need not be identical to one another). This may realize better data utilization in some layers, but may have the opposite effect in other layers. Again, because the accelerator is a hardware circuit, the register files cannot be changed at run-time, for example to account for data sparsity, data stationarity, or tensor shape within given layers.

However, those factors can be known beforehand, and different register file configurations can realize performance advantages in different layers. For example, if IF is highly-stationary in layer 2, it may be advantageous to provide a larger register (e.g., 128 bytes) for IF in that layer. But if IF is not stationary in layer 3, then the register configuration that was highly-efficient in layer 2 can be highly-inefficient in layer 3.

Thus, it is desirable to provide a system with flexible register file allocations from layer to layer. Given flexible register files, before an AI problem is loaded to the hardware accelerator, the register configurations can be optimized on a per-layer basis. The AI system designer knows, at design time, the data sparsity, tensor shapes, and data stationarity that will occur in each layer. Based on those factors, the designer can schedule the registers to have more or less capacity for a given layer, to optimize memory usage. In general highly-stationary data may better utilize larger registers, while sparse data may better utilize smaller registers.

To provide flexible registers, a hardware accelerator may be provided with elastic register files. These include a register file that is divided into a plurality of sub-banks of a given number of bytes each. Input multiplexers and output de-multiplexers are connected to the inputs and outputs respectively of the register banks. This enables the system programmer to select a tensor (i.e., one of IF, FL, or OF) for each sub-bank individually. The system designer can craft a per-layer register schedule that accounts for the data shape and structure of each layer. This register schedule can be loaded into the accelerator circuit before the AI network is executed, and the accelerator can then apply the schedule to each layer as it becomes active.

The teachings of this specification may be embodied in various example implementations. One example includes a method, comprising: generating a plurality of layer-specific register schedules for a deep learning neural network, wherein at least two layer-specific register schedules are different from one another, and wherein the layer-specific register schedules are to divide a register file into a plurality of tensor-specific registers, wherein the register file comprises a plurality of discrete sub-banks, and wherein the tensor-specific registers each comprise one or more of the sub-banks; and programming an AI hardware circuit with the plurality of layer-specific register schedules, comprising programming a configuration register to provide the layer-specific register schedules, and instructing the AI hardware circuit to start.

There is also disclosed an example, wherein the plurality of tensor-specific registers include registers for input feature (IF), output feature (OF), and filter weight (FL).

There is also disclosed an example, wherein the layer-specific register schedules are for a plurality of register files, and wherein the schedule for the plurality of register files are the same within a layer.

There is also disclosed an example, wherein the register files are associated with respective PEs of the AI hardware circuit.

There is also disclosed an example, wherein generating a layer-specific register schedule comprises providing a smaller register for a tensor with sparse data within a layer, compared to a tensor with non-sparse data in the layer.

There is also disclosed an example, wherein generating a layer-specific register schedule comprises providing extra capacity for a tensor with high stationarity within the layer.

There is also disclosed an example, wherein generating a layer-specific register schedule comprises accounting for tensor shape within the layer.

One example is a method of performing an AI inference, including: programming an AI accelerator circuit to solve an AI problem with a plurality of layer-specific register file (RF) size allocations, wherein the AI accelerator circuit comprises PEs with respective associated RFs, wherein the RFs individually are divided into K sub-banks of size B bytes, wherein B and K are integers, and wherein the RFs include circuitry to individually allocate a sub-bank to one of input feature (IF), output feature (OF), or filter weight (FL), and wherein programming the plurality of layer-specific RF size allocations comprises accounting for sparse data within the layer; and causing the AI accelerator circuit to execute the AI problem, including applying the layer-specific RF size allocations at run-time.

There is also disclosed an example, wherein the PEs are multiplier-accumulators (MACS).

There is also disclosed an example, wherein B is one of 1, 2, 4, 8, 16, 32, 64, or 128.

There is also disclosed an example, wherein B is between 1 and 128.

There is also disclosed an example, wherein the AI circuit is a DNN.

There is also disclosed an example, wherein the AI circuit is a CNN.

There is also disclosed an example, wherein programming the plurality of layer-specific RF size allocations comprises accounting for stationary data within the specific layers, wherein stationary data comprises data that change infrequently within a specific layer.

One example is an apparatus, such as an AI accelerator circuit, comprising: a plurality of substantially identical processing element circuits, the plurality of PE circuits configured to provide a discrete numerical operation for the AI accelerator circuit to carry out an AI algorithm; a plurality of register files communicatively coupled to and associated with respective circuits of the PE circuits, the register files configured to store at least two species of data and having a total capacity C_{TOT} bytes divided into K sub-banks of B bytes each, the K sub-banks having input and output multiplexer circuits configured to selectively assign individual sub-banks to one of the at least two species of data; and control circuitry configured to change, at runtime, sub-bank assignments for different layers of a neural network of the AI accelerator.

There is also disclosed an example, wherein the PE circuits are multiplier-accumulator (MAC).

There is also disclosed an example, wherein the PE circuits are substantially identical to one another in hardware.

There is also disclosed an example, wherein the control circuitry comprises input-side multiplexer and output-side demultiplexers for the respective sub-banks.

There is also disclosed an example, wherein the at least two species of data comprise three species of data.

There is also disclosed an example, wherein the three species of data comprise an input feature (IF), output features (OF), and filter weight (FL).

There is also disclosed an example, wherein the register files comprise at least one dedicated sub-bank per each of the at least two species of data.

There is also disclosed an example, wherein the dedicated sub-banks lack input and output multiplexers.

There is also disclosed an example, wherein B=1.

There is also disclosed an example, wherein B=4.

There is also disclosed an example, wherein B=8.

There is also disclosed an example, wherein B=16.

There is also disclosed an example, wherein B=32.

There is also disclosed an example, wherein the species of data comprise tensor inputs and/or outputs for the AI algorithm.

There is also disclosed an example, wherein the neural network is a CNN.

There is also disclosed an example, wherein the CNN is a DNN.

There is also disclosed an example, further comprising counter and glue logic circuitry to maintain active layer and state data about the DNN.

There is also disclosed an example, wherein the control circuitry is to assign the sub-banks according to per-layer attributes of hidden layers of the DNN.

There is also disclosed an example, wherein the control circuitry is to account for data sparsity in allocating the sub-banks.

There is also disclosed an example, wherein the control circuitry is to account for per-layer tensor dimensions in assigning the sub-banks.

There is also disclosed an example, wherein the AI accelerator circuit is an ASIC.

There is also disclosed an example, wherein the AI accelerator circuit is an FPGA.

There is also disclosed an example, wherein the AI accelerator circuit is an intellectual property (IP) block.

There is also disclosed an example of one or more tangible, nontransitory storage media having stored thereon one or more masks or instructions to fabricate or realize the AI accelerator circuit.

There is also disclosed an example of an apparatus, comprising: a processing element circuit configured to perform a computation using a plurality of input and/or output species; a register file communicatively coupled to the PE circuit and comprising a plurality of hardware sub-registers; and runtime-programmable selection circuitry to allocate the sub-registers of the register file to respective ones of the input and/or output species.

There is also disclosed an example, wherein the PE circuit is to perform a mathematical operation for an AI problem.

There is also disclosed an example, wherein the PE circuit is a multiplier-accumulator (MAC).

There is also disclosed an example, further comprising a plurality of PE circuits having associated therewith respective register files.

There is also disclosed an example, wherein the plurality of PE circuits are substantially identical to one another.

There is also disclosed an example, wherein the selection circuitry comprises an input-side multiplexer, and an output-side demultiplexer.

There is also disclosed an example, wherein the input and/or output species comprise three species of input and/or output values.

There is also disclosed an example, wherein the register file comprises K sub-registers of common size B bytes.

There is also disclosed an example, wherein B=1.

There is also disclosed an example, wherein B=4.

There is also disclosed an example, wherein B=8.

There is also disclosed an example, wherein B=16.

There is also disclosed an example, wherein B=32.

There is also disclosed an example, wherein the register file comprises at least one dedicated sub-register for each of the input and/or output species.

There is also disclosed an example, wherein the dedicated sub-registers lack selection circuitry.

There is also disclosed an example, wherein the input and/or output species comprise tensor inputs and/or outputs for an AI problem.

There is also disclosed an example, wherein the PE circuits are to provide a CNN for the AI problem.

There is also disclosed an example, wherein the CNN is a DNN.

There is also disclosed an example, further comprising counter and glue logic circuitry to maintain active layer and state data about the DNN.

There is also disclosed an example, further comprising control circuitry to program the selection circuitry at runtime.

There is also disclosed an example, wherein the control circuitry is to account for data sparsity in allocating the sub-registers.

There is also disclosed an example, wherein the control circuitry is to account for per-layer tensor dimensions in allocating the sub-registers.

There is also disclosed an example, wherein the input and/or output species comprise an input feature (IF) tensor, an output feature (OF) tensor, and a filter weight (FL) tensor.

There is also disclosed an example, wherein the apparatus is an AI accelerator circuit.

There is also disclosed an example, wherein the AI accelerator circuit is an ASIC.

There is also disclosed an example, wherein the AI accelerator circuit is an FPGA.

There is also disclosed an example, wherein the AI accelerator circuit is an IP block.

There is also disclosed an example of ne or more tangible, nontransitory storage media having stored thereon one or more masks or instructions to fabricate or realize the AI accelerator circuit.

There is also disclosed an example of a method of performing an AI inference, comprising: receiving input data; providing the input data to an input layer of a DNN circuit, the DNN circuit comprising PEs with respective register files, wherein the respective register files comprise K banks of sub-registers of B bytes divisible between input feature (IF), output feature (OF), and filter weight (FL) tensors; for hidden layers of the DNN, programming the respective register files with a per-layer allocation between IF, OF, and FL, wherein the per-layer allocation accounts of tensor shapes within the layer; and providing an inference as an output.

There is also disclosed an example, wherein the PEs are multiplier-accumulators (MACS).

There is also disclosed an example, wherein B=1.

There is also disclosed an example, wherein B=4.

There is also disclosed an example, wherein B=8.

There is also disclosed an example, wherein B=16.

There is also disclosed an example, wherein B=32.

There is also disclosed an example, wherein the DNN is a CNN.

There is also disclosed an example, further comprising accounting for data sparsity within a layer.

There is also disclosed an example of an apparatus comprising means for performing the method.

There is also disclosed an example, wherein the means for performing the method comprise an AI accelerator circuit.

There is also disclosed an example, wherein the AI accelerator circuit is an ASIC.

There is also disclosed an example, wherein the AI accelerator circuit is an FPGA.

There is also disclosed an example, wherein the AI accelerator circuit is an IP block.

There is also disclosed an example of one or more tangible, nontransitory storage media having stored thereon one or more masks or instructions to fabricate or realize the AI accelerator circuit.

There is also disclosed an example, wherein the means for performing the method comprise a processor and a memory.

There is also disclosed an example, wherein the memory comprises machine-readable instructions, that when executed cause the apparatus to perform the method.

There is also disclosed an example of at least one computer-readable medium comprising instructions that, when executed, implement a method or realize an apparatus as described above.

A further example provides one or more tangible, non-transitory computer-readable media having stored thereon instructions to configure a deep neural network (DNN) accelerator circuit, the instructions comprising: generating a plurality of layer-specific register schedules for the DNN accelerator circuit, wherein at least two layer-specific register schedules are different from one another, and wherein the layer-specific register schedules are to divide a register file into a plurality of tensor-specific registers, wherein the register file comprises a plurality of discrete sub-banks, and wherein the tensor-specific registers each comprise one or more of the sub-banks; sending the plurality of layer-specific register schedules, along with a deep learning problem, to a neural network hardware accelerator; and instructing the DNN accelerator circuit to begin executing.

There is also disclosed an example, wherein the plurality of tensor-specific registers includes registers for input feature (IF), output feature (OF), and filter weight (FL).

There is also disclosed an example, wherein the layer-specific register schedules are for a plurality of register files, and wherein the schedules for the plurality of register files are the same within a layer.

There is also disclosed an example, wherein the register files are associated with respective processing elements of the neural network accelerator circuit.

There is also disclosed an example, wherein generating a layer-specific register schedule comprises providing a smaller register for a tensor with sparse data within a layer, compared to a tensor with non-sparse data in the layer.

There is also disclosed an example, wherein generating a layer-specific register schedule comprises providing extra capacity for a tensor with high stationarity within the layer.

There is also disclosed an example, wherein generating a layer-specific register schedule comprises accounting for tensor shape within the layer.

### DESCRIPTION OF THE DRAWINGS

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

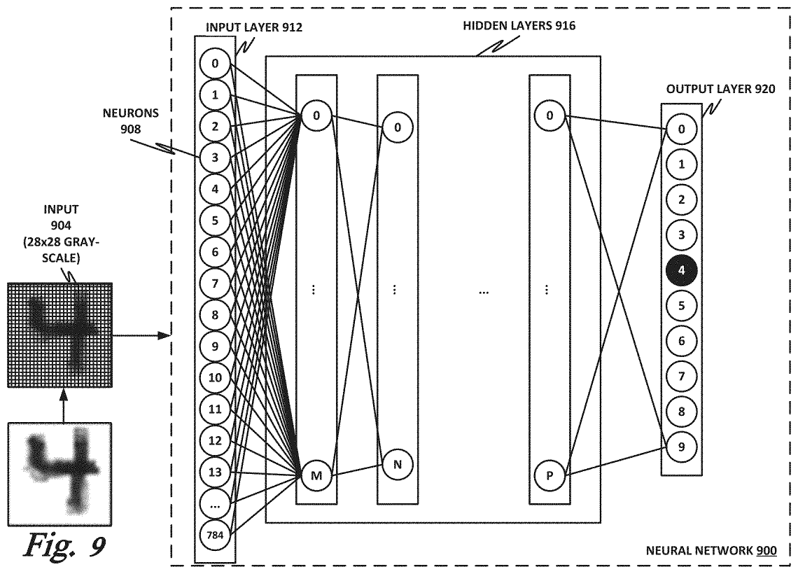

A DNN operates by propagating output values from one layer to the next and using the output values of the preceding layer as input values in the succeeding layer. A more detailed description of the operation of a DNN is illustrated in FIGS. 9-12 below. In FIG. 9, the inputs and outputs of each layer may be tensors, which are N-dimensional arrays of values (where “N” is an integer) as described in more detail below. Commonly, a hardware platform or a hardware accelerator that provides a CNN may include a bank of processing elements (PEs). The PEs may be, for example, multiplier-accumulator (MAC) circuits that perform discrete convolution operations for each neuron in each layer. The MACs may access the tensors, and perform a convolution function as a multiply-and-accumulate operation in a form such as a←a+(b×c). In this example b and c are tensors that need to be convolved and the resulting output stored in tensor a, and more specifically, a may be the output map (OF), b may be the weight or filter (FL), and C may be the input map (IF).

While these tensors may be stored in a main memory structure or multiple layers of memory, such as a DRAM, SRAM, or one or more layers of cache, to ensure that the MAC circuit operates at true hardware speed, the values for each layer may be loaded into hardware RFs associated with the MAC units. For example, there may be one RF or set of RFs for each MAC unit, or one set of RFs for each group of n MAC units. These RFs are very fast storage locations, similar to hardware registers in general-purpose central processing units (CPU). The MAC units can access the registers in a single or a few clock cycles, versus higher levels of cache or memory, which may be accessible in tens, hundreds, or thousands of clock cycles.

Throughout the remainder of this specification, an illustrative embodiment in which there is one register file assigned for each MAC unit will be used as an example. These examples can be extended to other configurations. The present specification provides a dataflow-aware and sparsity-aware elastic capacity for the input feature (IF) or input activation, output feature (OF) or output activation, and weight of filter (FL). For example, each MAC unit may have a register file of total capacity C_{TOT}, and that total capacity may be elastically or dynamically divided between IF, OF, and FL.

In existing systems, the RF capacity is divided into three discrete registers, such as an IF register, an OF register, and an FL register. These may have fixed capacities, for example of 64 bytes or some other value (e.g., between 4 and 256 bytes). However, the fixed register capacity may result in inefficiencies, as described below.

Thus, the present specification provides an improvement to the AI accelerator circuit, including RFs with dynamic or elastic capacity that realizes increases in efficiencies. This may be accomplished by dividing the RF into a plurality of K sub-banks or sub-registers, each having a capacity of B bytes, where K and B are both integers. Input and output multiplexers (such as 3-to-1 and 1-to-3 multiplexers) are used to select which species of tensor (i.e., variable) is assigned to each sub-bank. A theoretically-best embodiment may be where B=1, and where K is equal to the total size of the RF. This configuration provides the ability to dynamically allocate individual bytes of the RF to the different tensors at will. In real-world use cases, B=1 may not be feasible, because of the number of muxes, with the associated costs in space and circuit power, that would be required. Thus, design tradeoffs may drive the adoption of other values of B, such as an integer between 2 and 128 bytes, and in particular, any one of 2, 4, 8, 16, 32, 64, or 128 bytes by way of illustrative and nonlimiting example.

With the RF divided into K discrete sub-banks, tensor assignments may be changed at runtime. For example, an RF may have a nominal capacity of 64 bytes per tensor, for a total of 192 bytes (64 bytes for each of IF, OF, and FL). If this is an elastic RF with K=48 (e.g., B=4), each of the 48 discrete 4-byte sub-banks may be dynamically assigned to any one of IF, OF, or FL at runtime. In a highly-balanced layer, each tensor may receive its nominal 64 bytes, or something close. But in an extreme case of stationarity in IF, for example, as few as 4 bytes each could be assigned to OF and FL, leaving 184 bytes for IF. This allows a large chunk of IF data to be loaded into the IF register, which saves on accesses to higher-level memory. This provides for efficient data orchestration in DNN inference accelerators.

Neural networks are a rapidly evolving aspect of AI. Recently, neural networks have seen growth in the number of inference algorithms being proposed as well as hardware platforms upon which these algorithms can be accelerated. Network layers for the underlying deep learning inference algorithms come in many possible tensor shapes, the dimensions of which may keep changing within very short time spans.

For example, the sequence of activation and weight data orchestration within a network layer, referred to as a “schedule” or “dataflow,” relies heavily on the layer dimensions, underlying hardware architecture, and the level of sparsity in the data. Sparsity refers to the fact that some values in the array may be zero, and these zero-value elements can be optimized out.

The schedule in dataflow can vary significantly based on the network, hardware platform, and the input data set under consideration. Given the widely varying profile of network layer dimensions, hardware platform constraints, and sparsity content of input data set, it is advantageous to build flexible DNN accelerator hardware that can support efficient data orchestration schedules.

In some state-of-the-art flexible schedule DNN accelerators, the hardware provides the ability to generate schedules corresponding to different DNN dataflows, such as weight-stationary, output-stationary, and no local reuse by way of illustrative and nonlimiting example. These cater to the different network layer dimensions. However, some of the schedules generated by a schedule generator may be suboptimal from a data orchestration standpoint because the same schedule may be used for every layer in the neural network.

In one type of design, each species of tensor (IF, FL, and OF) resides in its own private physical register file. In many cases, sparsity and stationarity factors lead to one or more of the register files not being fully utilized. This is because each of the individual register files have a predetermined capacity that is fixed statically by the hardware. Many designs have been used to alleviate the utilization imbalance, such as storing all the different types of data in a single monolithic structure. However, reading and writing from this large global buffer is often power hungry and places limits on the chip operating frequency.

Depending on the layer dimension, a generated optimal schedule may prioritize compute cycles or compute utilization, with a corresponding negative effect on the RF capacity utilization. When RFs are not 100 percent utilized, memory capacity is wasted, and the amount of data reuse can be suboptimal.

The architecture of the present specification provides an elastic register file, which is a hardware solution that enables capacity borrowing among the unused capacity in the IF, FL, and/or OF register files to further reduce data movement and to improve the performance of the schedule. With the inclusion of the configurable register file feature, the schedule generator can leverage the feature to generate schedules that have better data movement profiles by saving on the number of accesses to higher levels of the memory hierarchy. Advantageously, the scheduler can change the allocation between different layers of the DNN. Thus, the scheduler can optimize the design at runtime.

Thus, the elastic register file provides a hardware technique that facilitates effective use of the available capacity that would have otherwise been wasted by borrowing the unused RF capacity from one RF and allocating it to another RF. Thus, even though the IF, FL, and OF register files have a static dedicated capacity in hardware, the present hardware technique unlocks the potential of increasing the capacity of any of these register files via capacity borrowing from one RF that has unused capacity to another RF that could use the additional capacity. This promotes a higher degree of data reuse among all the RFs in aggregate, resulting in fewer read data accesses to cache, SRAM, or other higher levels of memory.

Because efficient data orchestration solutions promote energy efficiency in DNN accelerators, the present specification provides a technique that empowers the scheduler to process network layers of arbitrary dimensions with varying levels of sparsity in data.

As an example, an ResNet-50 network may have a res2_branch1 layer. The capacity of this layer may be 128 bytes. In this example, the IF dimension is 56×56×54. The FL is 1×1×64×256. The OF is 56×56×256. The scheduler can optimize the FL data movement from SRAM-to-RF by 50 percent and achieve a two times reduction in FL memory traffic. This leads to significant savings in energy consumption due to the reduction in overall SRAM-to-RF memory traffic. Because of the increase in IF register file capacity, the system uses fewer SRAM access for FL.

However, statically increasing the RF storage capacity would negatively impact the area and reduce the operating frequency of the DNN accelerator. The runtime configurable register file of the present specification utilizes capacity borrowing within the IF, FL, and OF register files to achieve higher efficiency with reduced data movement and higher operating frequencies. It can achieve these advantages without statically increasing the dedicated RF capacity in hardware.

The elastic RF of the present specification realizes numerous advantages over existing systems. For example, the present specification enables an increase in RF capacity among RFs with static, dedicated capacity of storage. It utilizes capacity by borrowing unused capacity within individual RFs to reduce the overall data movement to improve performance. This realizes advantages over DNN accelerators in which the IF, FL, and OF register files are implemented as separate dedicated physical structures, each having a capacity that is statically fixed in hardware. Such a system provides no opportunity to share the unused capacity to other RFs.

Further advantageously, the present specification provides a system that is schedule-aware. The elastic RF can increase the storage capacity of RFs engaged in active compute via borrowing of unused capacity based on the DNN dataflow. This can be determined by the schedule, and thus allow more data to be brought into the RF that holds the stationary data. This achieves a higher degree of data reuse.

By facilitating a higher degree of data reuse, the present system allows the schedule generator to choose an optimal schedule from a data orchestration viewpoint. This optimized schedule helps to minimize the load memory traffic between the SRAM and RF storage closest to the compute resources.

Further advantageously, the present system is sparsity-aware. The level of sparsity in data can alter the schedule for a given network layer. The present system can support such variations in schedule based on the level of sparsity in data while delivering superior performance in terms of data orchestration compared to some existing systems that are sparsity-unaware.

Further advantageously, the present specification provides a system that implements the use of RF storage capacity that was previously wasted. This system enables the allocation of an entire RF capacity across a wide range of network layer dimensions and levels of sparsity in data. This helps to provide higher data reuse within the DNN accelerator. For an activation-stationary schedule, where the IF is resident within the RF for a longer period, expanded capacity for the IF register file can be borrowed from any unused capacity within the FL or OF register files. For a weight-stationary schedule, spare capacity can be borrowed from IF or OF. Similarly, for an output-stationary schedule, both the IF and the FL capacity may be increased concurrently by borrowing from the OF, thereby allocating RF capacity that might have been wasted previously.

Further advantageously, configuration registers within the system may be programmed via software that can alter the capacity of the IF and OF as well as FL on a per-layer basis.

Further advantageously, the present specification reduces the SRAM-to-RF traffic for IF and FL data. In experimental implementations, SRAM-to-RF traffic was reduced by between 33.3 and 98.4 percent compared to fixed static registers.

The foregoing can be used to build or embody several example implementations, according to the teachings of the present specification. Some example implementations are included here as nonlimiting illustrations of these teachings.

A system and method for runtime configurable register files for AI workloads will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

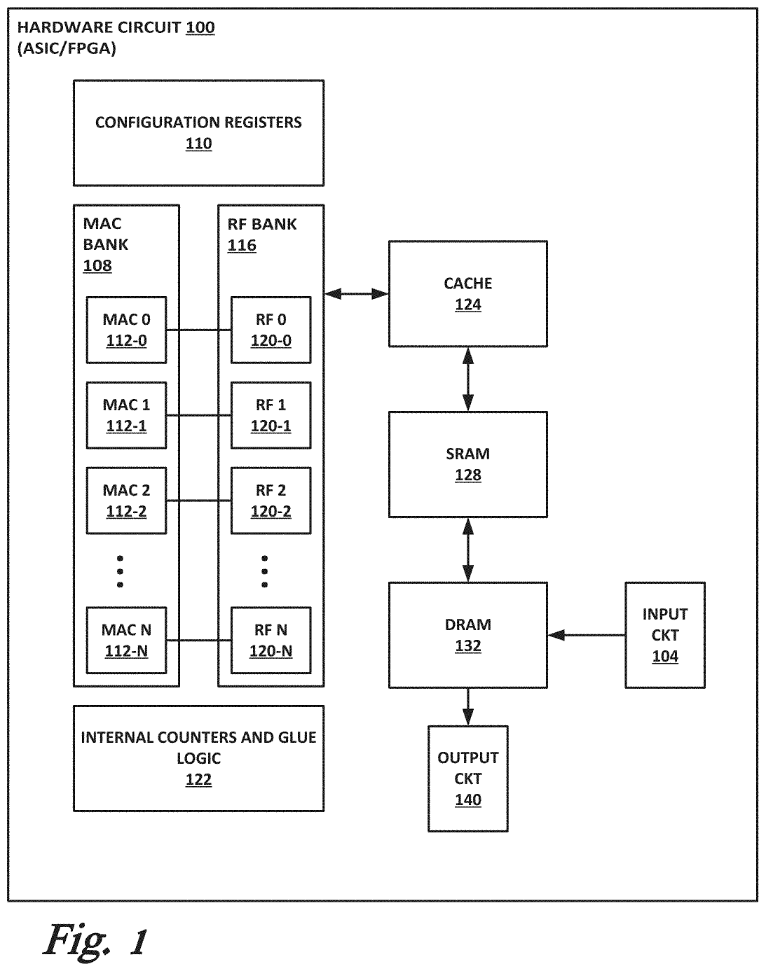

FIG. 1 is a block diagram of a hardware circuit 100, in accordance with various embodiments. Hardware circuit 100 could be, for example, an ASIC, an FPGA, or other circuit. Hardware circuit 100 could also be realized as an IP block or some other modular form factor that can be integrated into other designs. Hardware circuit 100 may be designed to provide an AI accelerator that performs DNN operations for inference or other computations. Hardware circuit 100 is a logical view of the DNN accelerator architecture, including a hierarchal memory feeding a plurality of PEs, which in this example are MACs. Hardware circuit 100 may be realized in many different aspects and form factors.

In this example, a MAC bank 108 includes a plurality of substantially-identical (in hardware) MAC units, such as MAC 0 112-0, MAC 1 112-1, MAC 2 112-2 through MAC N 112-N. Each MAC unit may be hardware coded to perform a multiply accumulate operation. In other embodiments, a compute circuit may be programmed to perform some other mathematical operation. Furthermore, the teachings of this specification may be adapted to other architectures, including general CPU or GPU compute architectures that may benefit from elastic register file allocation.

In this illustration, an RF bank 116 includes register files wherein there is a one-to-one association between register files and MAC units. For example, RF 0 120-0 is associated with MAC 0 112-0. RF 1 120-1 is associated with MAC 1 112-1. RF 2 120-2 is associated with MAC 2 112-2. RF N 120-N is associated with MAC N 112-N.

The hierarchal memory architecture of this example includes a cache 124, an SRAM 128, and a DRAM 132. In various implementations, some or all of these levels of memory may be omitted, or different memory architectures could be used.

Configuration registers 110 may be used to configure MAC bank 108 and RF bank 116. In some embodiments, RF bank 116 includes registers with elastic, runtime configurable memory capacity. In that case, configuration registers 110 may be used to program RF bank 116 for each layer. In other examples, RF bank 116 may be programmed with an RF architecture for the entire DNN.

Internal counters and glue logic 122 may be used to program a state machine, to propagate data from layer to layer in the neural network, to track the position of the neural network (e.g., which layer is being operated on), and other logic to provide the overall structure of the larger mathematical operation performed by the discrete MAC units.

As MAC bank 108 operates on various data, a MAC 112 may cause associated IF, FL, and/or OF tensors to be loaded into an associated RF 120. These data can be loaded from cache 124, SRAM 128, DRAM 132, or other.

Input circuit 104 may be programmed to receive inputs, such as input values or an input problem to operate on. Once the neural network has computed an inference, the result may be sent to output circuit 140, which can then send the output to an external destination.

Data movement—especially between various levels of memory such as between SRAM 128 and an RF 120—can be expensive compared to compute operations. Data movement is expensive both in terms of power and in terms of time. Thus, within the art of neural networks, there has been a shift toward allocating storage in the form of RFs in the memory hierarchy closest to compute. For example, because data movement is expensive, some existing architectures may have a MAC 112 operate directly on cache 124 or SRAM 128 if cache 124 is not present. This provides greater flexibility and obviates the need to move memory values between different memory levels in the hierarchy. Thus, in an example, the entire IF, FL, and OF data may be stored in a single monolithic off-chip DRAM 132 or a single monolithic on-chip SRAM 128.

While the capacity of DRAM 132 and SRAM 128 are shared among the IF, FL, and OF data, within the RFs 120 closest to compute MAC 112, existing methods may assign the IF, FL, and OF data statically, with the allocation fixed at design time.

In some existing architectures, the physical implementation of the accelerator architecture has RF storage implemented as separate physical structures with dedicated storage capacity allocated to each one of IF, FL, and OF data. This may be as opposed to a monolithic structure that contains all the IF, FL, and OF data together, such as within DRAM 132 or SRAM 128. In some cases, even the storage buffers that hold the IF, FL, and OF data are implemented as separate physical structures of fixed capacity.

Within existing structures, some advantages have been realized by moving away from a monolithic RF structure to a dedicated RF structure for each of IF, FL, and OF data. The expensive nature of adding multiple read and write ports to a monolithic RF is one factor driving the adoption of static dedicated register files for each tensor. For example, it would require at least three read and three write ports for a monolithic RF if the system needed to simultaneously access IF, FL, and OF data. In terms of area, clock period, and read energy, this has proved to be prohibitively expensive in some examples. Moreover, high-ported read and write RFs need to be custom-built or are not readily available, with the maximum-ported RF available from standard RF compilers being a 2R2 W RF.

Existing DNN accelerator architectures may support a fixed schedule. The RF storage capacity as well as the capacity of intermediate level storage buffers to store IF, OF, and FL data may be statically fixed and unalterable during execution or at runtime. The use of fixed schedules removes any need to modify storage capacity at runtime.

However, a fixed hardware and fixed schedule DNN accelerator may be suboptimal in terms of dealing with network layers of arbitrary dimensions measured via data movement from SRAM-to-RF. For example, table 1 below illustrates the loss of optimality for different schedule stationarities.

TABLE 1
Iso-RF DNN Accelerator Architecture

| Total SRAM Accesses | | | |
|---|---|---|---|
| (Lower is Better) | IF | FL | OF |
| IF | 1.00X | 38.86X | 1.00X |
| FL | 1.32X | 1.00X | 32.04X |
| OF | 6.36X | 19.88X | 1.00X |

Table 1 illustrates the total number of SRAM accesses as a function of the DNN accelerator fixed hardware and fixed schedule dataflow that it supports. The leading diagonal of the table (matching the hardware architecture and schedule dataflow) is most optimal with the off-digital elements being suboptimal. This emphasizes the need for designing flexible schedule DNN dataflow accelerators, including flexible underlying hardware that can be leveraged by the schedule generator to generate a more optimal or nearly optimal schedule.

Some existing systems have dealt with aspects of designing flexible DNN accelerators. However, these focus on the design of flexible data distribution models to enable flexible scheduling. For example, some systems may provide a flexible PE compute kernel to support variable shape tensor data processing in DNN accelerators. However, these systems do not take advantage of unused capacity in their static dedicated register file storage for IF, OF, and FL data.

Furthermore, these systems may not be sparsity-aware, and are thus suboptimal in dealing with sparse data. The level of sparsity in data can alter the schedule for a given network layer. For example, table 2 illustrates the impact of sparse data on the example network “Mobilenet_v2_deploy.”

TABLE 2
Sparse Data Impact

| | Dense | Dense | Sparse | Sparse |
|---|---|---|---|---|
| | Schedule | Schedule | Schedule | Schedule |
| | Inner | Outer | Inner | Outer |
| Layer Dimensions | Loop | Loop | Loop | Loop |
| IF: 56 × 56 × 24 | OX/4/2 | OC/4.5/1 | OX/4/2 | OC/9/1 |
| FL: 1 × 1 × 24 × 144 | OY/1/8 | OX/7/1 | OY/1/8 | OX/7/1 |
| OF: 56 × 56 × 144 | IC/12/2 | OY/7/1 | IC/12/2 | OY/7/1 |
| | OC/4/8 | | OC/2/8 | |

As illustrated in table 2, the dense schedule for the IF, FL, and OF register files are almost fully utilized, while for sparse data schedules, the register files are underutilized. A fixed, dedicated capacity RF implementation may not be able to utilize the unused capacity to bring in additional data from the outer rounds to improve the reuse factor.

However, if hardware circuit 100 is instead provided with elastic register files, as described herein, capacity can be shared between the various input and output tensors, to account for sparsity of data, different tensor dimensions, and different stationarities.

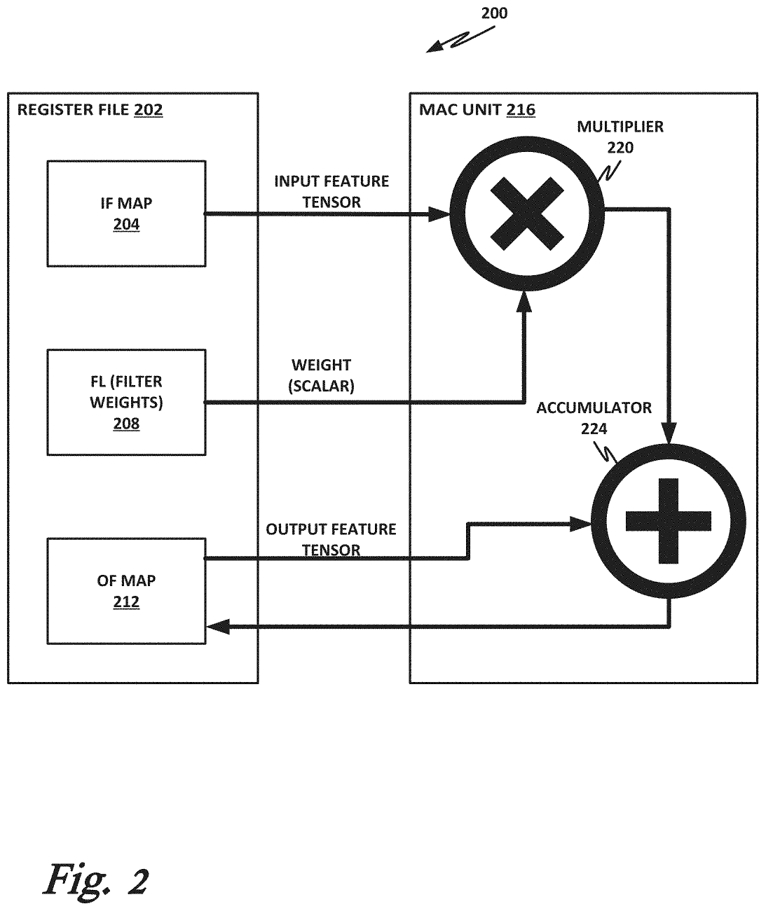

FIG. 2 is a block diagram of a subcircuit 200. Subcircuit 200 is a logical view of selected aspects of a MAC unit, such as a MAC 112 selected from MAC bank 108 of FIG. 1.

In this example, a register file 202 is divided into an IF map 204, an FL (filter weights) 208, and an OF map 212. IF map 204 provides an input tensor to MAC unit 216. Specifically, multiplier 220 receives the input feature tensor from IF map 204. Multiplier 220 also receives a scalar weight (which is a special zero-dimensional case of a tensor) as filter 208. Multiplier 220 computes a product of the IF map and the filter weight.

Accumulator 224 computes a sum, namely a sum of the OF tensor 212, with the product of the input feature tensor and scalar weight. This sum is then stored back to OF map 212.

An AI accelerator, such as hardware circuit 100 of FIG. 1, can realize substantial speed advantages by providing a bank of MAC units, such as the one shown here. In this example, register file 202 is illustrated as a conceptual register file. In the more general sense, register file 202 simply represents a data source that can be used by MAC unit 216. This could be implemented as physical registers of fixed or flexible capacity or a monolithic data structure, such as in an SRAM or DRAM.

As illustrated above, MAC unit 216 may realize efficiency advantages by having a register file 202 with flexible register capacity, wherein unused capacity in certain portions of the register file may be shared with other portions of the register file.

Embodiments of the present specification include hardware to alter the capacity of IF map 204, OF map 212, and/or filter 208 via elastic register files. This enables borrowing of unused capacity among RFs in the level or levels of memory hierarchy closest to the compute. Note that this technique can also be adapted to software methods, including software methods for problems other than AI or the DNN methods disclosed herein. In general terms, any hardware or software method that can benefit from a flexible register file, wherein portions of the register may be lent or borrowed, can benefit from the teachings of the present specification. Any such structure is intended to be included within the scope of the specification. In some embodiments, elastic registers are allocated between a set of fixed values, such as the three tensors (IF, OF, FL) shown by example herein, or other tensor or inputs and outputs. In other embodiments, an elastic register may be adjusted for use by general purpose data and methods.

Note that there are existing software programmable registers used to configure DNN accelerators for neural network layers. Configuration registers may be a superset of such registers.

This realizes advantages relative to existing systems, wherein the amount of storage for IF, OF, and FL are fixed at the outset. Elastic register files can modulate the capacity of RF storage allocated to IF, OF, and FL data. DNN accelerators that support activation-stationary, weight-stationary, as well as output-stationary schedules can significantly benefit from this elastic register file approach.

Preferences can be assigned to a desired tensor. For example, preference or additional weight can be assigned to IF versus OF versus FL in terms of storage capacity. The dataflow that is stationary or, in other words, the data that are resident in the RF for longer durations, can be assigned higher capacity, while the other faster changing dataflows can be assigned lower capacity. For activation-stationary schedules, the elastic RF system borrows any unused capacity in the FL and OF register files and allocates higher capacity to IF data. For weight-stationary schedules, the FL data are assigned higher capacity of storage via capacity borrowing from IF and OF register files. In the case of an output-stationary schedule where both activations and weights have identical preference, the elastic RF technique can allocate an equal weight of storage capacity to both IF and FL data by borrowing any unused capacity from the OF register file.

Thus, the elastic RF achieves efficient data movement by facilitating a high degree of data reuse across a wide sample of schedules (e.g., activation, weight, and output-stationary). Furthermore, because the schedule for a network layer is dependent on the level of sparsity in the data, the elastic RF technique can improve the data orchestration efficiency even in the presence of sparsity in weight and activation data.

The architecture illustrated herein addresses the trend of deploying more and more DNN accelerators on energy constrained devices. The DNN accelerators may perform inference on the mobile computing edge for various AI applications including, by way of illustrative and nonlimiting example, imaging, video, and speech applications. Efficient power management schemes may be important in edge devices that are battery-operated. Recent trends indicate that data movement may supersede the cost of computing itself as the controlling factor in such devices. Thus, enabling efficient data orchestration techniques via a high degree of data reuse can significantly enhance the energy and power efficiency of state-of-the-art DNN accelerators.

Embodiments of the elastic RF scheme illustrated herein may depend on the type of dataflow of the DNN schedule generated by a schedule generator. This may be in the form of a software compiler and may be programmed into the DNN accelerator via configuration registers. In an embodiment, there is introduced an identifier in the form of a flag or knob that enables the elastic RF feature within the schedule generator. For different flavors of network layer DNN dataflows, the software may program certain register fields to specify the amount of used and unused storage capacity of IF, OF, and FL register files. In some cases, additional pins may be provided to connect to the host CPU control/status registers.

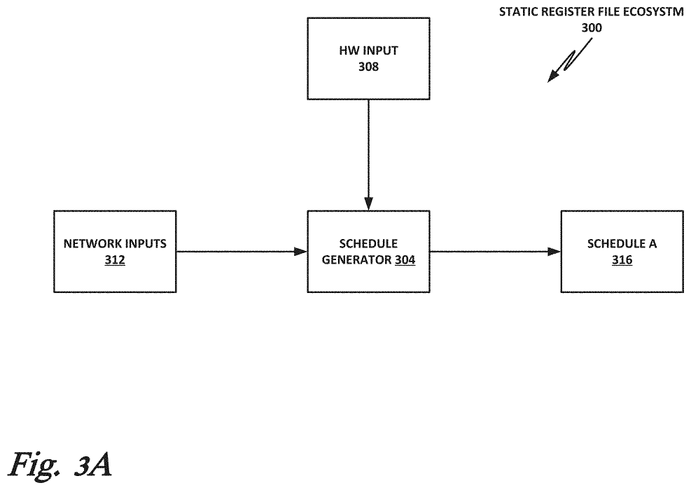

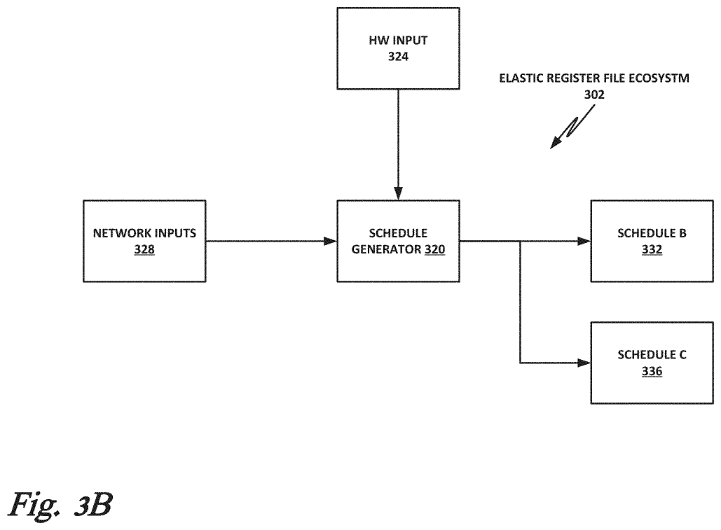

FIG. 3A is a block diagram of selected elements of a static register file ecosystem 300. This can be compared to FIG. 3B, which is a block diagram of selected elements of an elastic register file ecosystem.

Turning to FIG. 3A, ecosystem 300 includes a schedule generator 304. Schedule generator 304 accepts hardware inputs 308. This indicates a statically allocated dedicated register file capacity. Schedule generator 304 also receives network inputs 312, which are used to provide a schedule, such as schedule A 316. Network inputs 312 are the inputs to the DNN and may include, by way of illustrative and nonlimiting example, layer dimensions in the form of width (W), height (H), input channel (C), output channel (K), filter width (F_{w}), filter height (Fₕ), and stride (S).

From hardware input 308, schedule generator 304 knows of the static, dedicated IF, FL, and OF register file capacities for the accelerator. Based on this, schedule generator 304 creates schedule A 316, which is a schedule that applies to the entire network. In other words, schedule A 316 applies to each and every layer of the network and cannot be changed at runtime.

In FIG. 3B, there is disclosed an elastic register file ecosystem 302. This includes an alternative schedule generator 320. Schedule generator 320 is configured to provide elastic RF features to the neural network. Network input 328 may be identical or substantially identical to network input 312 of FIG. 3A. As before, schedule generator 320 may consider network inputs 328 such as W, H, C, K, F_{w}, Fₕ, and S. However, hardware input 324 is different from hardware input 308 of FIG. 3A. In this case, schedule generator 320 is made aware of the elastic RF features available in the hardware. This includes the ability to borrow unused RF capacity within IF, FL, or OF register files and to allocate the borrowed capacity to any of the other IF, FL, or OF register files to increase its capacity. The elastic RF feature empowers schedule generator 320 to generate schedules that are dataflow-aware as well as sparsity-aware, wherein the RF capacity is allocated to the RF that holds the stationary data by borrowing excess RF capacity that was previously unused by the other registers. For example, if IF is stationary, and if FL and OF are underutilized, then capacity can be borrowed from FL and/or OF and allocated to IF to better use the stationary data. More stationary data can then be loaded into IF, and the efficiency of the operation is increased because there are fewer data movements.

Thus, schedule generator 320 can generate schedule B 332 and schedule C 336 along with any other schedules that may be necessary. Schedule generator 320 may assign a different schedule to each layer in the neural network depending on the stationarity and/or sparsity of the data in that layer. In an illustrative example, schedule generator 320 may generate as many schedules as there are layers in the neural network. This provides superior data movement performance compared to schedule A 316 in terms of SRAM data accesses, because of the higher degree of data reuse enabled by elastic register files.

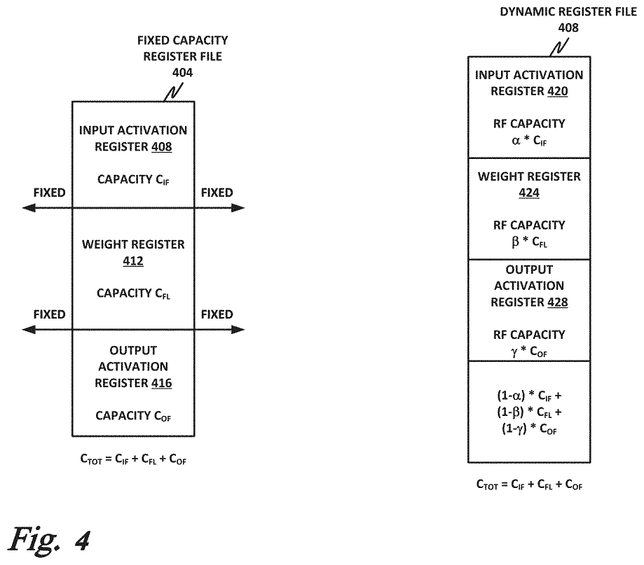

FIG. 4 is a block diagram of two register files illustrating differences between a fixed capacity register file and a dynamic register file.

Fixed capacity register file 404 includes an input activation register 408, a weight register 412, and an output activation register 416. In the case of fixed capacity register file 404, input activation register 408 has a fixed capacity C_{IF}. Weight register 412 has a fixed capacity C_{FL}. Output activation register 416 has a fixed capacity C_{OF}. The total byte capacity of the register file is C_{TOT}=C_{IF}+C_{FL} C_{OF}.

In a common use case, registers 408, 412, and 416 are stored hierarchically closest to the compute units (e.g., MACs or similar). Their storage capacity is static and dedicated. Irrespective of the network layer dimensions and the dataflow of the schedule, the capacity of storage allocated to IF, OF, and FL remain statically assigned and fixed. In a case like an FPGA, these may be dynamically allocated at burn-in of the FPGA kernel, but once the FPGA is programmed, the register file sizes remain fixed for the entire neural network operation.

Dynamic register file 408 illustrates the concept of elastic registers. In the case of dynamic register file 408, the total capacity may remain the same. In other words, C_{TOT} for fixed capacity register file 404 may be the same as C_{TOT} for dynamic register file 408. However, the register allocations may be different. Each register may have a nominal capacity, such as C_{IF} for the IF or input activation tensor, C_{OF} for the OF or output activation tensor, and C_{FL} for the weight or filter tensor. The variables α, β, and γ may represent the amount actually in use for a particular layer, and are decimal values between 0 and 1.0 (e.g., 0=totally unused, 1=fully used). Thus, (1−α) may represent the capacity available to be “lent” to other tensors. For example, if IF uses 25% of its nominal capacity (α=0.25), then 75% ((1−α)=0.75) may be available to be lent to either OF or FL. Thus, register 420 uses α *C_{IF} bytes, register 424 uses β*C_{FL} bytes, and register 428 uses γ*C_{OF} bytes. The capacity available to be borrowed by another register (usually a register that is already fully-utilized, i.e., where one or more of α, β, or γ is 1.0) is (1−α)*C_{IF}+(1−β)*C_{FL}+(1−γ)*C_{OF}. This “spare” capacity can be allocated as needed between IF, FL, and OF registers, with a granularity determined by the size of each sub-bank.

If each register has a nominal capacity of 64 bytes, then C_{TOT} is 192 bytes. As illustrated below, there is a trade-off between the granularity for dividing the register file and the size and power consumption of the circuit. For example, each byte could be a unit, in which case the minimum value of C_{IF} is one byte, and the programmer has essentially unrestricted access to reprogram the sharing of register file bytes for each layer. However, one byte granularity may result in prohibitive size and power consumption for some use cases. So, a different granularity may be used, such as two bytes, 4 bytes, 8 bytes, 16 bytes, 32 bytes, 64 bytes, or some other measure.

Using 4 bytes as an illustrative use case, each register file 420, 424, 428, has a minimum capacity of 4 bytes. Thus, C_{IF} must be at least 4 bytes for input activation register 420. C_{FL} must be at least 4 bytes for weight register 424. C_{OF} must be at least 4 bytes for output activation register 428. The remaining sub-registers (e.g., blocks of 4 bytes) can be assigned as needed in 4-byte chunks. These can be borrowed or lent to other register files to account for the data paths, stationarity, and sparsity of each layer. Thus, once 4 bytes are reserved for IF, for example, the rest of the register file can be allocated to other register files as necessary for the layer.

Because the granularity is 4 bytes in this illustrative example, 4 bytes, 8 bytes, 12 bytes, 16 bytes, 20 bytes, 24 bytes, 28 bytes, 32 bytes, 36 bytes, 40 bytes, 44 bytes, 48 bytes, 52 bytes, 56 bytes, or 60 bytes can be lent to the other register files for their computations. On the other hand, if IF has high stationarity for this layer and can benefit from more than 64 bytes, then it may borrow additional bytes from the other register files, again in 4-byte increments.

In some embodiments, the different register files could have different granularities, and thus, could have different allocation sizes. However, as illustrated below, certain hardware advantages may be realized by using common hardware so that the register file block essentially has an array of identical byte groups (i.e., sub-registers) that can be allocated as required to the three different variables and their tensors.

The elastic RF storage scheme provides a two-part capacity for each of IF, OF, and the FL register files. There is a used capacity portion and an unused capacity portion that is available to be borrowed by other register files. The use capacity fraction of IF, FL, and OF may be denoted by α, β, and γ, respectively. Thus, the total unused storage capacity of the IF, FL, and OF register files can be denoted as: [1−α]*C_{IF}+[1−β]*C_{FL}+[1−γ]*C_{OF}.

The unused portion is available to be borrowed in part or entirely by any of the other register files. Tables 3 and 4 below illustrate the borrowing. In this case, a 192-byte RF is assumed, with each tensor having a nominal size of 64 bytes.

TABLE 3
Data Allocation for an Example Dataflow (Formulaic)

| | First | Input | | Output |
|---|---|---|---|---|
| | Variable | Activation | Weight | Activation |
| | Outer | RF | RF | RF |
| Stationarity | Loop | Capacity (B) | Capacity (B) | Capacity (B) |
| Output | IC/*/1 | C_{IF} + 0.5 * (1 − γ) * | C_{FL} + 0.5 * (1 − γ) * | γ * C_{OF} |
| | | C_{OF} | C_{OF} | |
| Activation | OC/*/1 | (1 − β) * C_{FL} + C_{IF} + | β * C_{FL} | γ * C_{OF} |
| | | (1 − γ) * C_{OF} | | |
| Weight | OX/*/1 | α * C_{IF} | (1 − α) * C_{IF} + C_{FL} + | γ * C_{OF} |
| | OY/*/1 | | (1 − γ) * C_{OF} | |

TABLE 4
Data Allocation for an Example Dataflow (Byte Allocations)

| | First | Input | | Output |
|---|---|---|---|---|
| | Variable | Activation | Weight | Activation |
| | Outer | RF | RF | RF |
| Stationarity | Loop | Capacity (B) | Capacity (B) | Capacity (B) |
| Output | IC/*/1 | 80 | 80 | 32 |
| Activation | OC/*/1 | 128 | 32 | 32 |
| Weight | OX/*/1 | 32 | 128 | 32 |
| | OY/*/1 | | | |

In this example, each register file has 64 bytes, α=1.0, β=0.5, and γ=0.5. This results in 32 bytes of unused capacity from both FL and OF register files being borrowed by the IF register file to increase its capacity to 128 bytes from 64 bytes.

Table 3 illustrates the relative allocation of IF, OF, and FL register file storage capacity for various types of scheduled dataflows. For the output stationarity family of schedules, where the activations and weights are resident within the RF for equal duration, the unused storage capacity may be allocated equally to activations and weights. The unused capacity of RF volume, [1−α]*C_{IF}+[1−β]*C_{FL}+[1−γ]*C_{OF} is distributed equally to the activations and weights. When the schedule is activation-stationary, the elastic RF system assigns preferences to the activation storage capacity with the entirety of the unused RF capacity being borrowed by IF register file. On the other hand, for weight-stationary schedules, the elastic RF scheme treats weights in a preferential manner, allocating the integrity of the unused RF capacity to the FL register file.

In the examples above, a 64-byte register file for each register is used as an example. For α=0.5, β=0.5, γ=0.5, table 3 shows the IF, FL, and OF register capacity storage for output, activation, and weight-stationary schedules. The numbers shown above should be understood to be a concrete example, and the elastic RF concept is extensible enough to cover any value of C, α, β, and γ. In particular, while the elastic register file scheme is illustrated herein as a feature of an AI system, this scheme can be extended to any hardware architecture that would benefit from an elastic register file scheme.

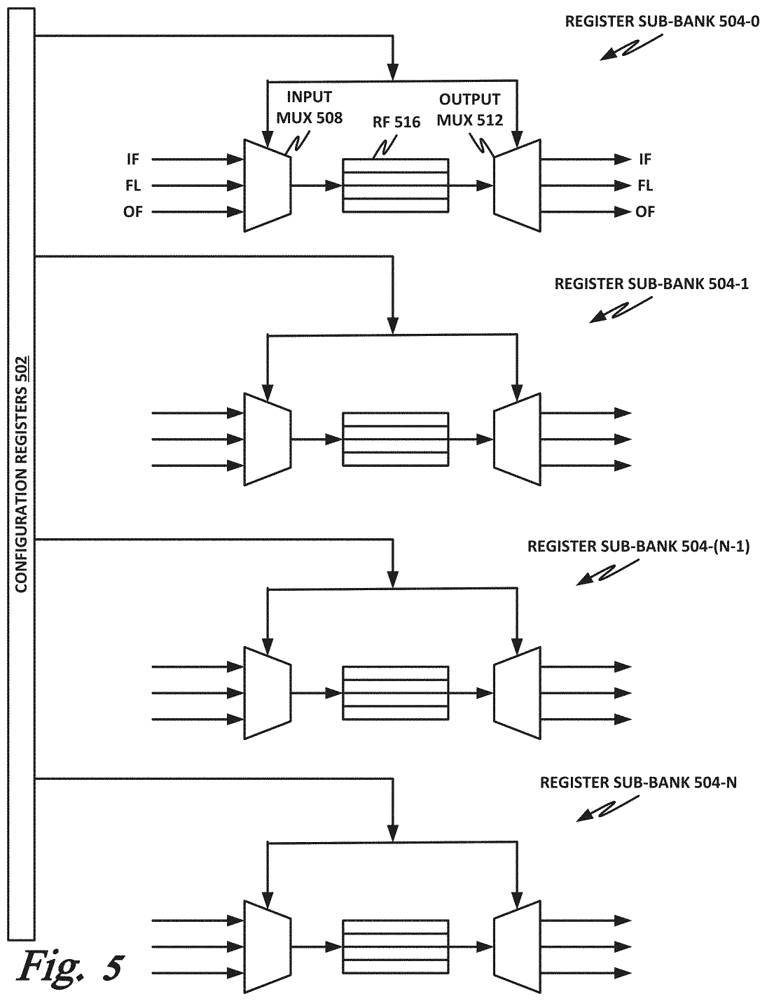

FIG. 5 is a block diagram illustrating selected aspects of an elastic register file hardware scheme. In this case, a configuration register or registers 502 controls a register sub-bank or a group of register sub-banks 504. For example, register sub-banks 504-0, 504-1 through 504-N are illustrated herein. Again, as a concrete illustration, each register sub-bank 504 may provide 4 bytes of available storage. Other sizes of register sub-banks could be provided, such as 1, 2, 4, 8, 16, 32, 64, or 128 bytes, by way of illustrative and nonlimiting example.

Register sub-banks 504 can be divided as necessary among IF, FL, and OF (or other tensors or general data) to realize the benefits of this specification. Each register bank 504 includes a register file 516 with the designated number of bytes available for that register file, e.g., in this case 4 bytes. In a static register file with C=64, 16 fixed register banks 504 would be hardwired to IF, another 16 would be hardwired to FL, and another 16 would be hardwired to OF. But in this case, a flexible register file allocation is provided. Each register file 516 has connected thereto an input multiplexer 508 and an output multiplexer 512. Input mux 508 receives signals from each of IF, FL, and OF. Similarly, output mux 512 is wired to provide its signal to each of IF, FL, and OF. In this example, both input mux 508 and output mux 512 receive a common selection input from configuration registers 502, which may provide an encoding to select the correct tensor for the register file. Thus, if input multiplexer 508 is programmed to receive IF, then output multiplexer 512 is also programmed to deliver IF.

In the case of a DNN, at least one register file 516 is allocated to each tensor. In some embodiments, one or more register files providing the minimum capacity may be hardwired to each one of IF, OF, and FL. This may save on the space and power cost of three extra multiplexers, where it is known that at least one register file 516 will always be allocated to each tensor.

The other register files can be dynamically allocated at runtime on a per-layer basis according to the stationarity, sparsity, and data needs of a particular layer. Note that a group of register banks 504 will together form the register set for a particular computation unit such as a single MAC. In other words, register sub-banks 504-0-504-N may form the elastic “register file” for a single MAC.

From a practical standpoint, it is efficient to divide the individual RF capacity into K banks, each of capacity C/K. K is an indicator of the discrete quantum of RF storage capacity increment that is lendable to one of the other register files depending on the schedule dataflow. The smaller the value of K, the lower the hardware overhead associated with the elastic RF scheme. Fewer banks means fewer encoders and decoders required as hardware overhead on the register file read and write paths. However, this also results in coarser granularity of control on the lendable RF capacity allocation. In this example, the step size of lendable RF capacity increment is large because of the small value of K.

On the other hand, having a larger value of K implies the ability to partition the individual capacity C into much finer granularity sub-banks, which allows greater control over the total lendable RF capacity allocation. The programmer may then choose individual banks of much finer size storage capacity. However, this comes at the expense of higher hardware area overhead as a larger number of banks translates into greater encoder and decoder area required on the RF read and write paths.

Configuration register 502 may be programmed via software depending on the schedule dataflow for the chosen DNN dataflow. It also may depend on the total number of bits in the elastic RF register, which may be expressed as 2*(3*K). This includes K banks for each of IF, OF, and FL, where each bank of bits indicate the polarity of data within an individual RF bank.

Configuration register 502 may provide an encoded bit value to select the appropriate input/output pairing for each sub-bank 504. In the case of the example DNN, there are three possible selection (e.g., IF, OF, and FL). In an example, a bit pair value of “00” indicates that the bank will be used to store output activation data (OF). A bit pair value of “01” indicates input activation data (IF). A bit pair value of “10” indicates weight/filter data (FL). Other bit encodings could also be used. Appropriate multiplexers may be inserted on the RF bank write and read paths, and the select signal to the corresponding bit pair value for that RF bank may be used from configuration register 502.

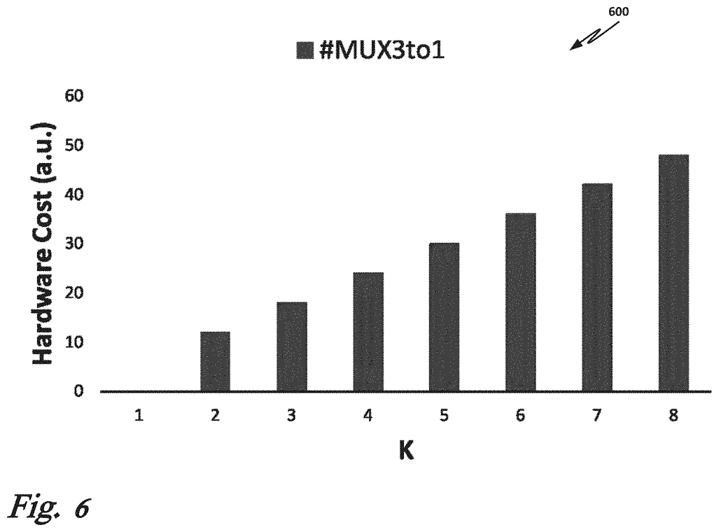

FIG. 6 is a graph 600 that illustrates the relative hardware cost of different configurations for different values of K. The value of K=1 corresponds to the baseline implementation (e.g., a static register file), as found in some existing systems. Increasing the value of K corresponds to the number of banks of each of IF, FL, and OF register files. This indicates the granularity of the division and the granularity of lendable sub-banks. As the number of banks K increases, there is a generally linear increase in the relative hardware cost and the number of 3-to-1 multiplexers. Increasing banks increases the number of 3-to-1 multiplexers that are added to the data path, and this eventually limits the scalability of the design. Thus, while it is theoretically desirable to have a large value of K for maximizing the lendable RF storage capacity allocation, practical considerations dictate that the relative hardware cost incurred in implementing the elastic RF scheme should also be considered. With higher values of K, there is more surface area use and more power consumption. K can be treated as a design-time option that can be used by software to determine how to utilize unused capacity given the ability to split into K banks. The value of K may be selected by a system designer according to the design considerations of the system.

Realization of Efficiency Gains

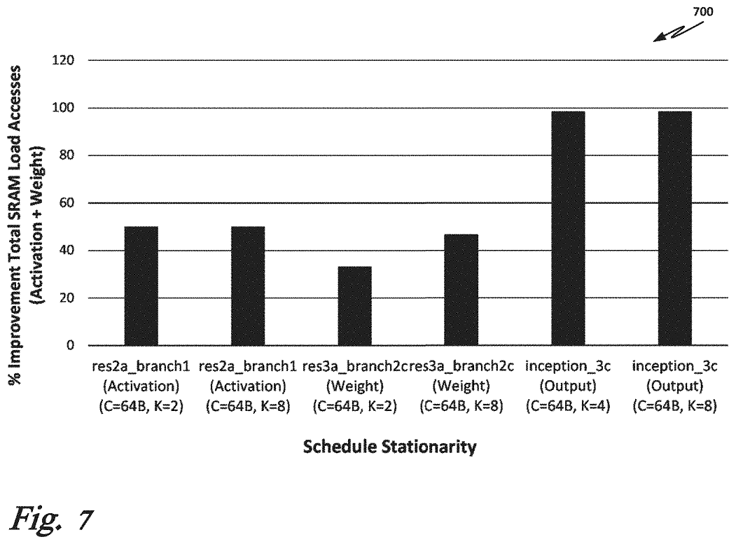

FIG. 7 is a graph 700 that illustrates the percent reduction in total SRAM load accesses from using an example elastic register file.

TABLE 5
FL SRAM Access Reduction

| | | | #Entry | | | | IF | FL |
|---|---|---|---|---|---|---|---|---|
| Schedule | Inner | Outer | IF/FL/OF | Inner | Outer | #Entry | Access | Access |
| Data-flow | Baseline | Baseline | Baseline | RF | RF | IF/FL/OF | Reduction | Reduction |
| Activation_1 | OX/1/8 | OC/256/1 | 64/32/2 | OX/1/8 | OC/256/1 | 128/32/4 | 0% | 50% |
| (C = 64B, | OY/2/14 | OX/7/1 | | OY/4/14 | OX/7/1 | | | |
| K = 2) | IC/32/2 | OY/2/1 | | IC/32/2 | | | | |
| Activation_2 | OX/1/8 | OC/256/1 | 64/32/2 | OX/1/8 | OC/256/1 | 128/32/4 | 0% | 50% |
| (C = 64B, | OY/2/14 | OX/7/1 | | OY/4/14 | OX/7/1 | | | |
| K = 8) | IC/32/2 | OY/2/1 | | IC/32/2 | | | | |
| Weight_1 | OC/8/16 | OX/28/1 | 8/64/8 | OC/12/16 | OX/28/1 | 8/96/12 | 33.3% | 0% |
| (C = 64B, | IC/8/16 | OY/28/1 | | IC/8/16 | OY/28/1 | | | |
| K = 2) | | OC/4/1 | | | OC/(8/3)/1 | | | |
| Weight_2 | OC/8/16 | OX/28/1 | 8/64/8 | OC/15/16 | OX/28/1 | 8/120/15 | 46.7% | 0% |
| (C = 64B, | IC/8/16 | OY/28/1 | | IC/8/16 | OY/28/1 | | | |
| K = 8) | | OC/4/1 | | | OC/(32/15)/1 | | | |
| Output_1 | OX/1/8 | IC/1.25/1 | 64/64/1 | OX/1/8 | OC/64/1 | 80/80/1 | 98.4% | 0% |
| (C = 64B, | OY/1/8 | OC/64/1 | | OY/1/8 | OX/3.5/1 | | | |
| K = 4) | IC/64/4 | OX/3.5/1 | | IC/80/4 | OY/3.5/1 | | | |
| | | OY/3.5/1 | | | | | | |
| Output_2 | OX/1/8 | IC/1.25/1 | 64/64/1 | OX/1/8 | OC/64/1 | 80/80/1 | 98.4% | 0% |
| (C = 64B, | OY/1/8 | OC/64/1 | | OY/1/8 | OX/3.5/1 | | | |
| K = 8) | IC/64/4 | OX/3.5/1 | | IC/80/4 | OY/3.5/1 | | | |
| | | OY/3.5/1 | | | | | | |

Table 5 shows the percent reduction in total number of SRAM load accesses (sum of activation SRAM load accesses and weight SRAM load accesses) using an elastic RF. The first column indicates the schedule dataflow type as well as the value of C and K. The columns “Inner”, “Outer” and “#Entry IF/FL/OF” with the qualifier “Baseline” and “elastic RF” appended refer to the schedule generated by the compiler for hardware without and with the elastic RF technique respectively. For the sake of brevity in explanation, the first term is the output dimension variable, the second term is the blocking factor, and the third term is the partitioning factor. For example, OX/1/8 in Inner and OX/8/1 in Outer indicates that each PE (e.g., a MAC) has 1 X point and there are 8 such identical PEs working on 8 independent X's spread across the multiple PEs spatially while there are 7 such outer rounds which are worked upon in 7 loops spread temporally. The #Entry IF/FL/OF indicates the number of IF, FL, and OF entries within the RF.

Several experimental results are disclosed.

Case A: Activation-Stationary Schedule (Row 1 & Row 2 in Table 5)

In the baseline scheme where the capacities of IF, FL, and OF register files are fixed to C=64B, the FL as well as OF RF suffers from capacity under-allocation while the IF RF cannot be expanded to accommodate additional IF points. This is alleviated in the elastic RF scheme where IF RF capacity is increased to accommodate 128B via capacity borrowing while the FL RF contains 32B. Owing to the increase of OY points in the inner loop, from OY/2/14 (28 OY points in total) in baseline schedule to OY/4/14 (56 OY points in total) in schedule supported by elastic RF, there is a subsequent reduction in OY outer loop from OY/2/1 to OY/1/1. Having a greater number of activation points in the inner loop (1*2*32=64 Baseline vs. 1*4*32=128 elastic RF) increases the efficacy of the activation-stationary schedule by enhancing the degree of activation reuse. This in turn reduces the weight load memory traffic from SRAM by 50% as weights must be brought into the PEs fewer number of times. Due to the reduction in weight data movement from SRAM to the compute units, the power/energy efficiency of flexible DNN accelerators is improved significantly. Similar analysis is shown for K=8 case. For this activation-stationary schedule, there is no additional memory traffic reduction by increasing the number of banks from K=2 to K=8.

Case B: Weight-Stationary Schedule (Row 3 & Row 4 in Table 5)

Similar analysis is shown for two flavors of K (K=2 and K=8) for weight-stationary schedules. With K=2 (Weight_1) the capacity of each RF bank is 64B/2=32B while for K=8 the capacity of each RF bank equals 64/8=8B. For the smaller value of K=2, the capacity of individual RF banks is large, so the system cannot achieve finer granularity of control on the total RF capacity management. (Baseline: IF=8B, Weight=64B gets updated to elastic RF: IF=8B, Weight=96B with 128−(96+8)=24B unused among IF and FL RFs). The quantum of RF capacity increment occurs in multiples of 32B which is the individual RF bank size for K=2. On the other hand, for K=8 (Weight_2), the size of individual RF bank is 8B which allows the weight RF capacity to be increased to 120B, such that the entire 128B RF capacity is shared between IF and weights. Having more weight points within the inner loop (96B for K=2 vs. 120B for K=8) increases the efficiency of the weight-stationary schedule with higher degree of weight data reuse within the PEs resulting in decrease of IF SRAM load accesses. (Baseline outer loop OC/4/1 is reduced to elastic RF outer loop OC/(8/3)/1 and OC/(15/32)/1 for K=2 and K=8 cases respectively) by 33.3% and 46.7% for K=2 and K=8 respectively.

The downside of increasing the value of K is having smaller sized RF banks, which increases the area overhead associated with encoders and decoders on the RF write and read paths (Weight_2 incurring more hardware overhead compared to Weight_1 schedule). The additional timing overhead incurred due to the multiplexers in the RF read and write paths were non-existent in the baseline implementation. However, if the RF read and write are not in the critical path and the critical path lies in the DNN accelerator multiply-and-accumulate data path units, then the timing overhead is zero. In the worst-case scenario, if the RF read and write lies in the critical path, there is minimal degradation in the maximum achievable frequency of operation of the DNN accelerator.

Case C: Output-Stationary Schedule (Row 5 & Row 6 in Table 5)

Lastly, for the output-stationary schedules, IF and FL are treated identically and are allocated equal RF storage capacity borrowed from the unused capacity. For K=4 case (Output_1), as well as for K=8 case (Output_2), there are significant savings in IF SRAM load accesses (98.4%) which is achieved due to the entire IF moving into the inner loop, made possible by the elastic RF. The system is able to allocate additional storage capacity in finer granularity chunks, which was not possible to achieve in the K<4 case. For K<4, elastic RF does not realize gains from SRAM load accesses reduction over the baseline implementation due to the large granularity of bank size not allowing addition IF and FL inner loop storage capacity allocation.

FIG. 7 illustrates a graph 700 of the elastic RF scheme applied to a few realistic layer dimensions from ResNet-50 and Inception networks, with reduction in activation and weight SRAM accesses.

With changes in the level of sparsity in data, the schedule for the layer changes and hence sparsity-awareness can be mirrored as schedule-awareness, which the elastic RF is capable of.

In summary, elastic RF can benefit network layers with wide ranging width (OX), height (OY), input channel (IC), output channel (OC), filter width (FX), filter height (FY) and stride (S) as well as varying degrees of sparsity in data. Elastic RF can ensure higher storage capacity allocation among IF, FL, and OF RFs via borrowing of unused RF capacity to achieve a higher degree of reuse in either IF, FL, or OF data.

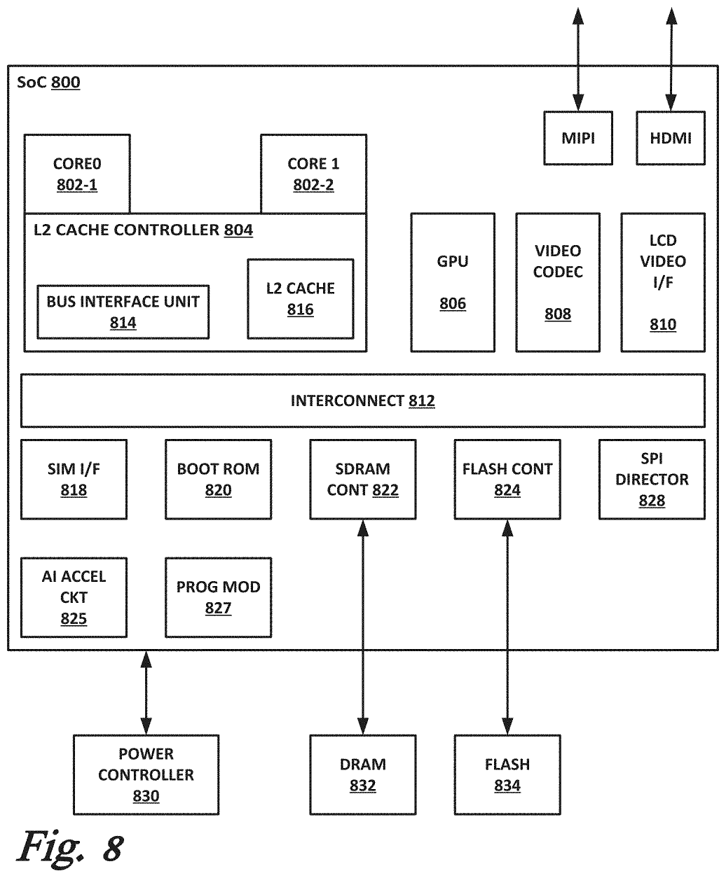

FIG. 8 is a block illustrating selected elements of an example SoC 800. At least some of the teachings of the present specification may be embodied on an SoC 800, or may be paired with an SoC 800. SoC 800 may include, or may be paired with, an advanced reduced instruction set computer machine (ARM) component. For example, SoC 800 may include or be paired with any ARM core, such as A-9, A-15, or similar. This architecture represents a hardware platform that may be useful in devices such as tablets and smartphones, by way of illustrative example, including Android phones or tablets, iPhone (of any version), iPad, Google Nexus, Microsoft Surface. SoC 800 could also be integrated into, for example, a PC, server, video processing components, laptop computer, notebook computer, netbook, or touch-enabled device.

As with hardware platform QB00 above, SoC 800 may include multiple cores 802-1 and 802-2. In this illustrative example, SoC 800 also includes an L2 cache control 804, a GPU 806, a video codec 808, a liquid crystal display (LCD) I/F 810 and an interconnect 812. L2 cache control 804 can include a bus interface unit 814, a L2 cache 816. Liquid crystal display (LCD) I/F 810 may be associated with mobile industry processor interface (MIPI)/HDMI links that couple to an LCD.

SoC 800 may also include a subscriber identity module (SIM) I/F 818, a boot ROM 820, a synchronous dynamic random access memory (SDRAM) controller 822, a flash controller 824, a serial peripheral interface (SPI) director 828, a suitable power control 830, a dynamic RAM (DRAM) 832, and flash 834. In addition, one or more embodiments include one or more communication capabilities, interfaces, and features such as instances of Bluetooth, a 3G modem, a global positioning system (GPS), and an 802.11 Wi-Fi.

Designers of integrated circuits such as SoC 800 (or other integrated circuits) may use intellectual property blocks (IP blocks) to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a nonvolatile memory (NVM) controller, Wi-Fi, Bluetooth, GPS, a fourth or fifth-generation network (4G or 5G), an audio processor, a video processor, an image processor, a graphics engine, a GPU engine, a security controller, and many other IP blocks. In many cases, each of these IP blocks has its own embedded microcontroller.

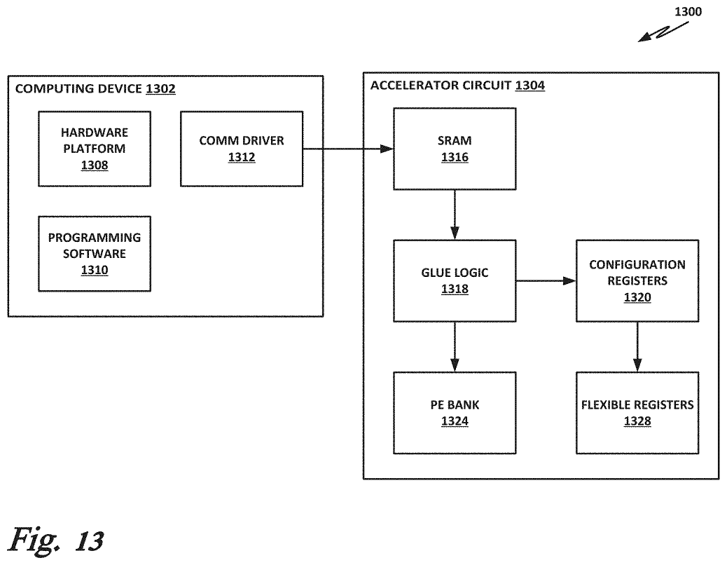

In an illustrative example, SoC 800 also includes an AI accelerator circuit 825. AI accelerator circuit 825 may be tightly coupled to SoC 800. A programming module 827 may include the necessary logic, software, or firm ware to program AI accelerator circuit 825. An example of such a configuration is illustrated in FIG. 13 below.

FIGS. 9-11 illustrate selected elements of an AI system or architecture. In these FIGURES, an elementary neural network is used as a representative embodiment of an AI or machine learning architecture or engine. This should be understood to be a nonlimiting example, and other machine learning or AI architectures are available, including for example symbolic learning, robotics, computer vision, pattern recognition, statistical learning, speech recognition, natural language processing, deep learning, convolutional neural networks, recurrent neural networks, object recognition and/or others.

FIG. 9 illustrates machine learning according to a “textbook” problem with real-world applications. In this case, a neural network 900 is tasked with recognizing characters. To simplify the description, neural network 900 is tasked only with recognizing single digits in the range of 0 through 9. These are provided as an input image 904. In this example, input image 904 is a 28×28-pixel 8-bit grayscale image. In other words, input image 904 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 900 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other AI architecture, to meet the demands of a particular problem. Indeed, the architecture here is sometimes referred to as the “Hello World” problem of machine learning and is provided as but one example of how the machine learning or AI functions of the present specification could be implemented.

In this case, neural network 900 includes an input layer 912 and an output layer 920. In principle, input layer 912 receives an input such as input image 904, and at output layer 920, neural network 900 “lights up” a perceptron that indicates which character neural network 900 thinks is represented by input image 904.

Between input layer 912 and output layer 920 are some number of hidden layers 916. The number of hidden layers 916 will depend on the problem to be solved, the available compute resources, and other design factors. In general, the more hidden layers 916, and the more neurons per hidden layer, the more accurate the neural network 900 may become. However, adding hidden layers and neurons also increases the complexity of the neural network, and its demand on compute resources. Thus, some design skill is required to determine the appropriate number of hidden layers 916, and how many neurons are to be represented in each hidden layer 916.

Input layer 912 includes, in this example, 784 “neurons” 908. Each neuron of input layer 912 receives information from a single pixel of input image 904. Because input image 904 is a 28×28 grayscale image, it has 784 pixels. Thus, each neuron in input layer 912 holds 8 bits of information, taken from a pixel of input layer 904. This 8-bit value is the “activation” value for that neuron.

Each neuron in input layer 912 has a connection to each neuron in the first hidden layer in the network. In this example, the first hidden layer has neurons labeled 0 through M. Each of the M+1 neurons is connected to all 784 neurons in input layer 912. Each neuron in hidden layer 916 includes a kernel or transfer function, which is described in greater detail below. The kernel or transfer function determines how much “weight” to assign each connection from input layer 912. In other words, a neuron in hidden layer 916 may think that some pixels are more important to its function than other pixels. Based on this transfer function, each neuron computes an activation value for itself, which may be for example a decimal number between 0 and 1.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 916, until they reach the last layer, which has P+1 neurons labeled 0 through P. Each of these P+1 neurons has a connection to each neuron in output layer 920. Output layer 920 includes neurons known as perceptrons that compute an activation value based on their weighted connections to each neuron in the last hidden layer 916. The final activation value computed at output layer 920 may be thought of as a “probability” that input image 904 is the value represented by the perceptron. For example, if neural network 900 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 916 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is a nontrivial problem, and may require greater sophistication in programming and training than is fairly represented in this simplified example.

The activation value for neurons in the input layer is the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

A common operation for the kernel is convolution, in which case the neural network may be referred to as a “convolutional neural network” (CNN). The case of a network with multiple hidden layers between the input layer and output layer may be referred to as a deep neural network. In current practice, convolutional DNNs (known as CNNs) are the most commonly used type of AI circuit or program.

In the case of a CNN, the convolution may be performed in software (as in a general purpose computer, or in GPU-based hardware), or in specialized hardware. For example, a multiplier-accumulator unit (MAC unit) is a special hardware circuit that performs a multiply-and-accumulate function of the form a←a+(b×c), where a is the OF, b is the input feature, and c is the filter weight. To increase precision, a “fused” multiply-add (FMA) may be performed in a single step, with no loss of resolution. In other words, FMA performs the multiply and add without any rounding of intermediate results. Only the final result is rounded to the available precision of the operation.

The basic data structure of a CNN is the tensor. A tensor is an n-dimensional structure of values, with n indices required to address a particular value. Scalars, vectors, and matrices are special cases of tensors. A scalar is a 0-dimensional tensor, or a single value. A vector is a 1-dimensional tensor, which can be addressed via a single index (e.g., t[i] can be used to identify a single value in tensor t). A matrix is a 2-dimensional tensor, which can be addressed via two indices (e.g., t[i][j]). In the general case, an n-dimensional tensor can be addressed via n indices. In memory, tensors are represented as n-dimensional arrays (e.g., the following pseudocode may represent a 4-dimensional tensor of integers with dimensions 256×256×64×12): int t[256][256][64][12];

Fundamental properties of tensors include rank, axes, and shape. Tensor rank refers to the number of dimensions of the tensor. For example, a 2-dimensional tensor (a.k.a., a matrix) has rank 2. Axes are the individual dimensions. For example, a rank 2 tensor has axis 0 and axis 1. In common usage, these may also be referred to as “x” and “y” axes. A three-dimensional axis has “x,” “y,” and “z” axes. Higher-rank tensors do not generally have common names for their axes, and the axes may be indicated by their order.

Tensor shape is a measure of the length of each axis. For example, a rank 3 tensor with 256 elements in axis 0, 256 elements in axis 1, and 64 elements in axis 2 has a shape of 256×256×64. This tensor has 786,342 total elements. A tensor can be reshaped, and commonly is in neural networks. Reshaping results in a tensor with the same number of overall elements, but a different rank or different axis lengths. The 256×256×64 tensor could be reshaped into a rank 2 tensor of shape 12288×64, a rank 4 tensor of 128×256×128, a rank 1 tensor (i.e., a vector) of 786,432 elements, or any other suitable shape that retains all 786,432 elements.

In computing the convolution, weights may be used for example to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a threshold for detecting the feature. For example, a large negative bias indicates that the feature should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (a) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

a₀⁽¹⁾=σ(w₀a₀⁽⁰⁾+w₁a₁⁽⁰⁾+ . . . w₇₈₃a₇₈₃⁽⁰⁾+b)

In this case, it is assumed that layer 0 (input layer 912) has 784 neurons. Where the previous layer has “n” neurons, the function can be generalized as:

a₀⁽¹⁾=σ(w₀a₀⁽⁰⁾+w₁a₁⁽⁰⁾+ . . . wₙaₙ⁽⁰⁾+b)

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

a⁽¹⁾=σ(Wa⁽⁰⁾+b)

Neural connections and activation values are propagated throughout the hidden layers 916 of the network in this way, until the network reaches output layer 920. At output layer 920, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 920 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values. A “validation set” can be used to validate the success of the training. The validation set has known values, like the training set, and the trained network can be run against the validation set, and the results measured.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

wheren w is a vector containing all the parameters (weights and biases) in the network. The minimum (absolute and/or local) can then be represented as a trivial calculus problem, namely:

$$\frac{d C}{d w} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer because the input layer receives activation values directly from the input image.

After a round of such nudging, the network may receive another round of training with the same or a different training data set, and the process is repeated until a local and/or global minimum value is found for the cost function.

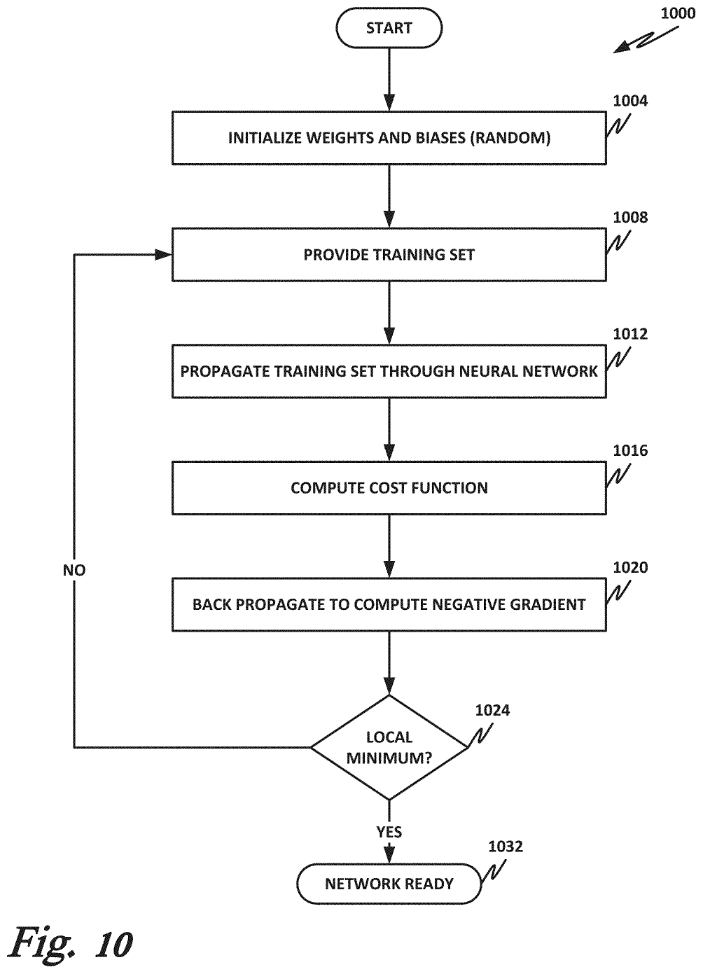

FIG. 10 is a flowchart of a method 1000, in accordance with various embodiments. Method 1000 may be used to train a neural network, such as neural network 900 of FIG. 9.

In block 1004, the network is initialized. Initially, neural network 900 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1008, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1008, the initial training set is provided to the neural network. Alternatively, the full training set could be used in each iteration.

In block 1012, the training data are propagated through the neural network. Because the initial values are random, and are therefore essentially garbage, it is expected that the output will also be a garbage value. In other words, if neural network 900 of FIG. 9 has not been trained, when input image 904 is fed into the neural network, it is not expected with the first training set that output layer 920 will light up perceptron 4. Rather, the perceptrons may have values that are all over the map, with no clear winner, and with very little relation to the number 4.

In block 1016, a cost function is computed as described above. For example, in neural network 900, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1020, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1024, the system determines whether it has reached a local minimum (e.g., whether the gradient has reached 0 within the threshold). If the local minimum has not been reached, then the neural network has not been adequately trained, and control returns to block 1008 with a new training set. The training sequence continues until, in block 1024, a local minimum has been reached.

Now that a local minimum has been reached and the corrections have been back-propagated, in block 1032, the neural network is ready.

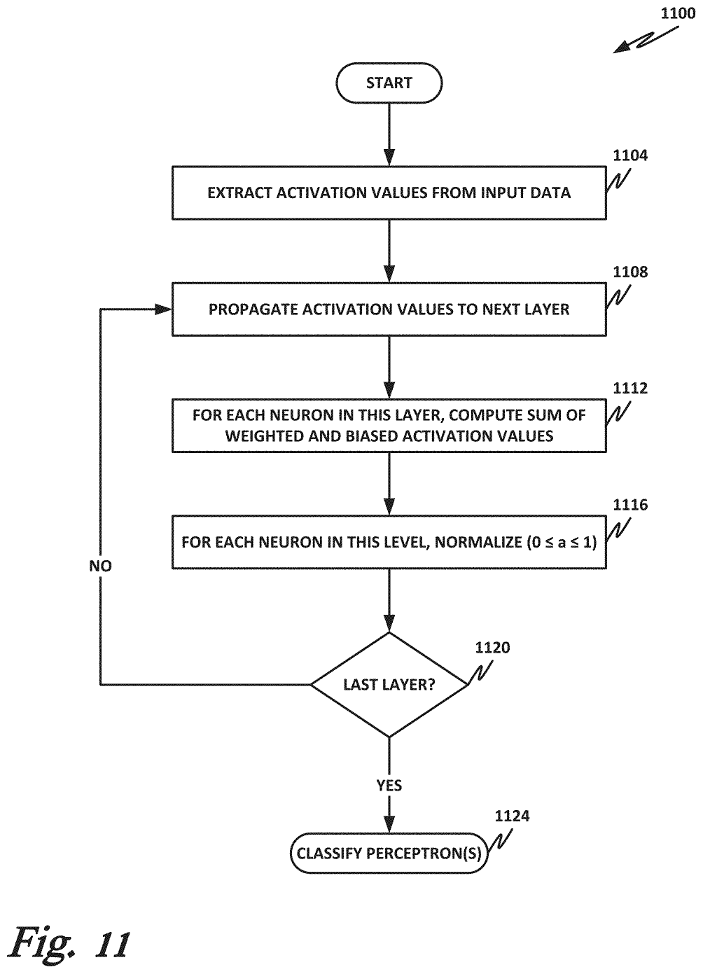

FIG. 11 is a flowchart of a method 1100. Method 1100 illustrates a method of using a neural network, such as network 900 of FIG. 9, to classify an object.

In block 1104, the network extracts the activation values from the input data. For example, in the example of FIG. 9, each pixel in input image 904 is assigned as an activation value to a neuron 908 in input layer 912.

In block 1108, the network propagates the activation values from the current layer to the next layer in the neural network. For example, after activation values have been extracted from the input image, those values may be propagated to the first hidden layer of the network.

In block 1112, for each neuron in the current layer, the neuron computes a sum of weighted and biased activation values received from each neuron in the previous layer. For example, in the illustration of FIG. 9, neuron 0 of the first hidden layer is connected to each neuron in input layer 912. A sum of weighted values is computed from those activation values, and a bias is applied.

In block 1116, for each neuron in the current layer, the network normalizes the activation values by applying a function such as sigmoid, ReLU, or some other function.

In decision block 1120, the network determines whether it has reached the last layer in the network. If this is not the last layer, then control passes back to block 1108, where the activation values in this layer are propagated to the next layer.

Returning to decision block 1120, If the network is at the last layer, then the neurons in this layer are perceptrons that provide final output values for the object. In terminal 1124, the perceptrons are classified and used as output values.

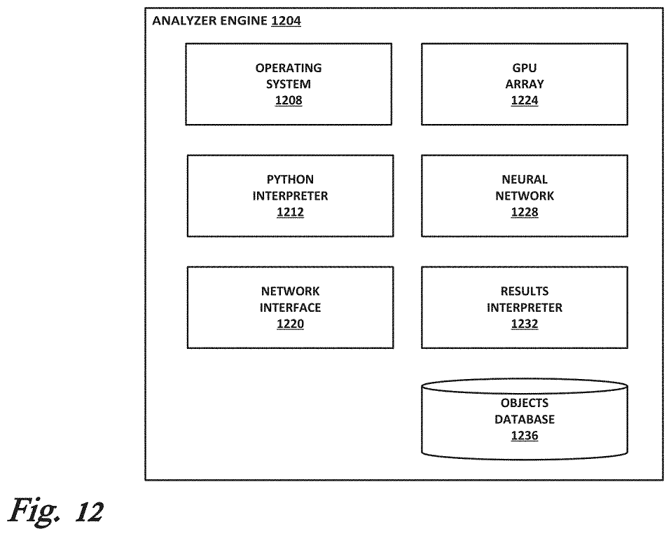

FIG. 12 is a block diagram illustrating selected elements of an analyzer engine 1204. Analyzer engine 1204 may be configured to provide analysis services, such as via a neural network. FIG. 12 illustrates a platform for providing analysis services. Analysis, such as neural analysis and other machine learning models, may be used in some embodiments to provide one or more features of the present disclosure.

Note that analyzer engine 1204 is illustrated here as a single modular object, but in some cases, different aspects of analyzer engine 1204 could be provided by separate hardware, or by separate guests (e.g., VMs or containers) on a hardware system.

Analyzer engine 1204 includes an operating system 1208. Commonly, operating system 1208 is a Linux operating system, although other operating systems, such as Microsoft Windows, Mac OS X, UNIX, or similar could be used. Analyzer engine 1204 also includes a Python interpreter 1212, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1224 may include an array of graphics processing units that may be used to carry out the neural network functions of neural network 1228. Note that GPU arrays are a popular choice for this kind of processing, but neural networks can also be implemented in CPUs, or in ASICs or FPGAs that are specially designed to implement the neural network.

Neural network 1228 includes the actual code for carrying out the neural network, and as mentioned above, is commonly programmed in Python.

Results interpreter 1232 may include logic separate from the neural network functions that can be used to operate on the outputs of the neural network to assign the object for particular classification, perform additional analysis, and/or provide a recommended remedial action.

Objects database 1236 may include a database of known malware objects and their classifications. Neural network 1228 may initially be trained on objects within objects database 1236, and as new objects are identified, objects database 1236 may be updated with the results of additional neural network analysis.

Once results have been obtained, the results may be sent to an appropriate destination via network interface 1220.

FIG. 13 is a block diagram of a circuit programming ecosystem, in accordance with various embodiments.

Circuit programming ecosystem 1300 includes an computing device 1302 and an accelerator circuit 1304. Computing device 1302 may be, for example, an engineering workstation or other suitable computing device, with an accelerator circuit 1304 attached thereto. In one example, accelerator circuit 1304 is a peripheral component interconnect express (PCIe) card that extends the functionality of computing device 1302, such as by providing hardware acceleration for AI problems. In another example, an SoC may include both computing device 1302 and accelerator circuit 1304 in a tightly-coupled configuration (e.g., with direct hardware connections), as illustrated in FIG. 8 above. In yet another example, computing device 1302 may be an orchestrator that managers a data center or cloud service. In that case, accelerator circuit 1304 could be attached as a PCIe extension to a rack-mounted server. Alternatively, accelerator circuit 1304 could be part of a “sled” of like devices in a rackscale architecture. In that case, the sled may provide a backplane connection to a network fabric, which may be or include, by way of nonlimiting example, Intel® Omni-Path™ Architecture (OPA), TrueScale™, Ultra Path Interconnect (UPI) (formerly called QPI or KTI), FibreChannel, Ethernet, FibreChannel over Ethernet (FCoE), InfiniBand, PCI, PCIe, or fiber optics, to name just a few. Many other configurations are possible between computing device 1302 and accelerator circuit 1304.

Computing device 1302 includes a hardware platform 1308. An example of a hardware platform is provided in SoC 800 of FIG. 8. Other hardware platforms could also be provided, and in general, any device having a suitable processor and memory (e.g., any “Von Neumann machine”) could be used for a hardware platform 1308.

Computing device 1302 includes a communication driver 1312, which enables computing device 1302 to communicate with accelerator circuit 1304. Accelerator circuit 1304 may be any suitable circuit provided with flexible or dynamic register files, as described throughout this specification. For example, hardware circuit 100 of FIG. 1 provides such an accelerator.

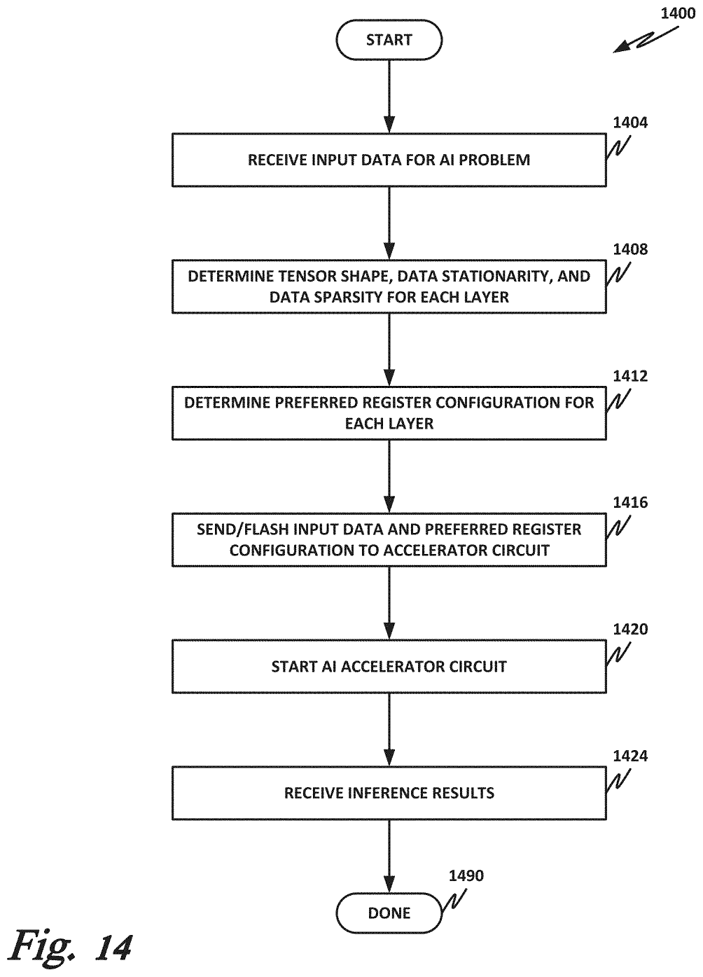

Computing device 1302 also includes programming software 1310. Programming software 1310 may include machine-executable instructions stored on one or more tangible, non-transitory computer-readable storage media. These instructions, when executed, instruct hardware platform 1308 to carry out certain methods, such as for example the method (or any part thereof) illustrated in FIG. 14 below.

In use, an engineer or other user operates programming software 1310 by selecting appropriate per-layer register configurations for various layers of a known neural network. In selecting the register configurations, the programmer may account for factors such as data sparsity, tensor shape, and other factors that may affect the efficiency of register usage within the layer. In some cases, programming software 1310 may include an application that assists the user in making appropriate register size selections.

Some existing solutions have similar software for aiding a user in finding optimal data sizes for particular tensors within a layer, accounting for factors such as data stationarity, data sparsity, and tensor shape for example. However, those existing systems are limited to the fixed register sizes provided by the circuit. For example, the software could determine that 128 bytes is the preferred size for the IF tensor within a layer. But if the accelerator circuit had fixed 64-byte registers, the software can allocate at most 64 bytes for IF. The only option for getting a larger register of 128 bytes was to reconfigure the circuit (e.g., reconfigure an FPGA) with larger IF registers. However, those register configurations were then fixed for the entire NN. If in a different layer, less space was needed for IF, the excess capacity was wasted.

In contrast, an accelerator circuit of the present specification may provide elastic registers, wherein the register sizes can be reconfigured at runtime on a per-layer basis. In that case, the software may be able to “borrow” excess capacity from other registers within the same register file, subject only to the constraints of the resolution of the register sub-banks, and in some cases, the requirement that one or more sub-banks may be “reserved” for each tensor as a minimum register size for that tensor.

Thus, when interfacing with an accelerator circuit of the present specification, the configuration software is free to allocate larger registers for a particular tensor. The software may do this by borrowing from sub-banks from other registers within the same register file, if a particular layer calls for a larger data size for a particular tensor.

After the user has finalized the per-layer register file selections, programming software 1310 may operate communications driver 1312 to send the NN inputs and per-layer register configurations to accelerator circuit 1304.

Accelerator circuits 1304 receives the NN inputs and per-layer register configurations into SRAM. These data may be used to program glue logic 1318, which tracks the active layer and layer-to-layer data propagation. Glue logic 1318 may also use the per-layer register configurations to program configuration registers 1320 with the register configuration for the active layer of the NN.

Configuration registers 1320 program flexible registers 1328 with the desired register configuration for the active layer. For example, appropriate values may be provided to multiplexers and/or demultiplexers, as illustrated in FIG. 5.

With the appropriate data available in SRAM 1316, and the desired register configuration applies to flexible registers 1328, PE bank 1324 can then execute the mathematical operation for the layer, such as by performing a number of parallel MAC operations.

FIG. 14 is a flow chart of a method 1400 of programming a hardware circuit, in accordance with various embodiments. Method 1400 may be performed, in whole or in part, by an computing device such as computing device 1300 of FIG. 13, or by any other suitable device.

In block 1404, the device receives the input data for an AI problem that can be solved by an NN, such as by a DNN accelerator circuit as described throughout this specification.

In block 1408, the operator determines the tensor shape, data sparsity, data stationarity, and other relevant information for each layer in the DNN. These factors influence the preferred register file size for each layer.

In block 1412, the user determines the preferred register configuration for each layer, according to the inputs received in block 1408. In some cases, computer software may also assist the user in determining a preferred register configuration, such as by providing hints or suggestions for a particular layer.

In block 1416, the system sends the configuration to an AI accelerator circuit, such as hardware circuit 100 of FIG. 1 or some other suitable circuit. This may include flashing a ROM, sending the data to a flash memory or some other SRAM, or performing some other action that loads the appropriate data to the accelerator circuit.

In block 1420, the system starts the accelerator circuit, such as by applying power, or sending a “start” signal to the circuit. The accelerator circuit then performs the DNN inference computation in hardware, including using the per-layer register configurations provided.

In block 1424, the system receives from the accelerator circuit the inference results from the DNN. The user may then apply the results as necessary.

In block 1490, the method is done.

Variations in Implementation

The foregoing outlines features of several embodiments so that those skilled in the art may better understand various aspects of the present disclosure. The foregoing detailed description sets forth examples of apparatuses, methods, and systems relating to a system for runtime configuration of register files in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to am embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or runtime memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1. A method, comprising:
generating a plurality of layer-specific register schedules for a deep learning neural network, wherein at least two layer-specific register schedules are different from one another, and wherein the layer-specific register schedules are to divide a register file into a plurality of tensor-specific registers, wherein the register file comprises a plurality of discrete sub-banks, and wherein the tensor-specific registers each comprise one or more of the sub-banks; and
programming an artificial intelligence (AI) hardware circuit with the plurality of layer-specific register schedules, comprising programming a configuration register to provide the layer-specific register schedules.

2. The method of claim 1, wherein the plurality of tensor-specific registers include registers for input feature (IF), output feature (OF), and filter weight (FL).

3. The method of claim 1, wherein the layer-specific register schedules are for a plurality of register files, and wherein the schedule for the plurality of register files are the same within a layer.

4. The method of claim 3, wherein the register files are associated with respective processing elements of the AI hardware circuit.

5. The method of claim 1, wherein generating a layer-specific register schedule comprises providing a smaller register for a tensor with sparse data within a layer, compared to a tensor with non-sparse data in the layer.

6. The method of claim 1, wherein generating a layer-specific register schedule comprises providing extra capacity for a tensor with high stationarity within the layer.

7. The method of claim 1, wherein generating a layer-specific register schedule comprises accounting for tensor shape within the layer.

8. An apparatus, comprising:
a plurality of processing element (PE) circuits to provide one or more neuron layers for a neural network;
a plurality of register files communicatively coupled to and associated with respective circuits of the PE circuits, the register files comprising circuitry to store a plurality of species of data and each having a total capacity C_{TOT} bytes, the C_{TOT} bytes divided into sub-banks of B bytes each, wherein C_{TOT} and B are integers, the sub-banks having input and output multiplexer circuits configured to selectively assign the sub-banks to selected inputs or outputs of the PEs, wherein the inputs or outputs represent a plurality of species of data; and
control circuitry configured to change, at runtime, sub-bank assignments according to an active layer of the neural network.

9. The apparatus of claim 8, wherein the PE circuits are substantially identical to one another in hardware.

10. The apparatus of claim 8, wherein the PE circuits are multiplier-accumulator (MAC).

11. The apparatus of claim 8, wherein the control circuitry comprises input-side multiplexer and output-side demultiplexers for the respective sub-banks.

12. The apparatus of claim 8, wherein the at least two species of data comprise three species of data.

13. The apparatus of claim 12, wherein the three species of data comprise an input feature (IF), output feature (OF), and filter weight (FL).

14. The apparatus of claim 13, wherein the register files comprise at least one dedicated sub-bank per each of the three species of data.

15. The apparatus of claim 14, wherein the dedicated sub-banks lack input and output multiplexers.

16. The apparatus of claim 8, wherein B is between 1 and 128.

17. The apparatus of claim 8, wherein the species of data comprise input tensors or output tensors for the neural network.

18. The apparatus of claim 8, wherein the control circuitry further comprises stored per-layer register configurations for the register files.

19. The apparatus of claim 18, wherein the per-layer register configurations account for data sparsity and data stationarity within individual layers of the neural network.

20. The apparatus of claim 18, wherein the per-layer register configurations account for tensor dimensions within individual layers of the neural network.

21. One or more tangible, non-transitory computer-readable media having stored thereon instructions to configure a deep neural network (DNN) accelerator circuit, the instructions comprising:
generating a plurality of layer-specific register schedules for the DNN accelerator circuit, wherein at least two layer-specific register schedules are different from one another, and wherein the layer-specific register schedules are to divide a register file into a plurality of tensor-specific registers, wherein the register file comprises a plurality of discrete sub-banks, and wherein the tensor-specific registers each comprise one or more of the sub-banks;
sending the plurality of layer-specific register schedules, along with a deep learning problem, to a neural network hardware accelerator; and
instructing the DNN accelerator circuit to begin executing.

22. The one or more tangible, non-transitory computer-readable media of claim 21, wherein the plurality of tensor-specific registers includes registers for input feature (IF), output feature (OF), and filter weight (FL).

23. The one or more tangible, non-transitory computer-readable media of claim 21, wherein the layer-specific register schedules are for a plurality of register files, and wherein the schedules for the plurality of register files are the same within a layer.

24. The one or more tangible, non-transitory computer-readable media of claim 23, wherein the register files are associated with respective processing elements of the neural network accelerator circuit.

25. The one or more tangible, non-transitory computer-readable media of claim 21, wherein generating a layer-specific register schedule comprises providing a smaller register for a tensor with sparse data within a layer, compared to a tensor with non-sparse data in the layer.

26. The one or more tangible, non-transitory computer-readable media of claim 21, wherein generating a layer-specific register schedule comprises providing extra capacity for a tensor with high stationarity within the layer.

27. The one or more tangible, non-transitory computer-readable media of claim 21, wherein generating a layer-specific register schedule comprises accounting for tensor shape within the layer.
